(19) United States
(12) Patent Application Publication
(10) Pub. No.: US 2026/0110981 A1
(43) Pub. Date: Apr. 23, 2026

(54) DEVELOPING APPARATUS

(71) Applicant: CANON KABUSHIKI KAISHA, Tokyo (JP)

(72) Inventor: Kosuke Takeuchi, Chiba (JP)

(21) Appl. No.: 19/351,521

(22) Filed: Oct. 7, 2025

(30) Foreign Application Priority Data
Oct. 18, 2024 (JP) 2024-184367

(51) Int. Cl. G03G 15/08

(52) U.S. Cl. CPC G03G 15/0818; G03G 15/0815; G03G 15/0889; G03G 15/0891; G03G 2215/085

(57) ABSTRACT

A developing apparatus includes a developing container, a first rotatable developing member, a first magnet provided non-rotatably and stationarily inside the first rotatable developing member, a second rotatable developing member, a second magnet provided non-rotatably and stationarily inside the second rotatable developing member, and a duct including a suction port that is an inlet through which the developer scattered in the developing container is sucked. The position on the outer peripheral surface of the second rotatable developing member where the absolute value of the normal component of the magnetic flux density of a sixth magnetic pole of the second magnet becomes maximum is positioned downstream of an edge of a first duct wall of the duct on the suction port side with respect to the rotational direction of the second rotatable developing member.

### BACKGROUND

### Field of the Technology

The present disclosure relates to a developing apparatus that develops an electrostatic latent image formed on an image bearing member with a developer.

### Description of the Related Art

As a developing apparatus, a configuration including a peeling roller for peeling and collecting a developer from a developing roller that develops an electrostatic latent image formed on an image bearing member with a developer has been proposed (Japanese Patent Application Laid-Open Publication No. 2018-124338). The developing roller includes a developing sleeve that rotates, and a developing magnet disposed non-rotatably inside the developing sleeve, wherein the developer is borne on a surface of the developing sleeve by magnetic force of the developing magnet. Similarly, the peeling roller includes a peeling sleeve that rotates, and a peeling magnet disposed non-rotatably inside the peeling sleeve, wherein the developer is borne on a surface of the peeling sleeve by magnetic force of the peeling magnet. The developer having been carried and fed by the developing sleeve and used to develop the electrostatic latent image on the image bearing member, i.e., used developer, is borne on the surface of the peeling sleeve, by which the developer on the developing roller is collected by the peeling roller. Then, by the rotation of the peeling sleeve, the developer borne on the peeling sleeve is conveyed to a peeling position, and the developer is peeled off from the peeling sleeve.

According to the configuration disclosed in Japanese Patent Application Laid-Open Publication No. 2018-124338, the peeling sleeve is rotated such that the surface of the peeling sleeve moves in an opposite direction as the surface of the developing sleeve at an opposing portion opposing the developing sleeve. In this state, during a process of delivering the developer from the developing sleeve to the peeling sleeve, scattering of toner caused by collapse of napping of the developer between magnetic poles during feeding of the developer being delivered from the developing sleeve to the peeling sleeve and fed to the peeling position may occur, and scattering of detached toner during peeling may also occur.

Along with the recent increase in speed of the image forming apparatus, such scattering of toner from the peeling roller has become an issue, and many developing apparatuses are provided with a duct for sucking the toner that has been scattered inside the developing apparatus. However, in such a configuration, a carrier that has been scattered together with the scattered toner from the peeling roller is collected by the duct, such that the duct may be clogged by the carrier. When the duct is clogged by the carrier, the ability of the duct to suck the scattered toner is deteriorated, such that toner scattering may not be suppressed sufficiently.

### SUMMARY

One aspect of the present disclosure is to suppress the collecting of carrier by the duct.

According to one aspect of the present disclosure, a developing apparatus includes a developing container including a first chamber configured to contain a developer including a toner and a carrier, and a second chamber partitioned from the first chamber by a partition wall, a first rotatable developing member to which the developer is supplied, the first rotatable developing member being configured to carry and feed the developer to a developing position where an electrostatic latent image formed on an image bearing member is developed, a first magnet provided non-rotatably and stationarily inside the first rotatable developing member, the first magnet having a first magnetic pole provided to face the image bearing member at the developing position, a second magnetic pole provided downstream of the first magnetic pole in a rotational direction of the first rotatable developing member, and a third magnetic pole provided downstream of the second magnetic pole and adjacent to the second magnetic pole, with respect to the rotational direction of the first rotatable developing member, and having a same magnetic polarity as that of the second magnetic pole, a second rotatable developing member disposed to face the first rotatable developing member and configured to receive the developer delivered from the first rotatable developing member by a magnetic field generated by the first magnet, the second rotatable developing member being configured to carry and feed the developer after developing the electrostatic latent image in the second chamber to collect the developer in the second chamber, a second magnet provided non-rotatably and stationarily inside the second rotatable developing member, the second magnet having a fourth magnetic pole having a different magnetic polarity from that of the second magnetic pole, a fifth magnetic pole provided downstream of the fourth magnetic pole with respect to a rotational direction of the second rotatable developing member, a sixth magnetic pole provided downstream of the fifth magnetic pole and adjacent to the fifth magnetic pole, with respect to the rotational direction of the second rotatable developing member, and having a different magnetic polarity from that of the fifth magnetic pole, and a seventh magnetic pole provided downstream of the sixth magnetic pole and adjacent to the sixth magnetic pole, with respect to the rotational direction of the second rotatable developing member, and having a same magnetic polarity as that of the sixth magnetic pole, wherein the developer after developing the electrostatic latent image is delivered from the first rotatable developing member to the second rotatable developing member by a magnetic field generated between the second magnetic pole and the fourth magnetic pole, and, a duct including a suction port that is an inlet through which the developer scattered in the developing container is sucked, the suction port being disposed downstream, in the rotational direction of the second rotatable developing member, of a position at which the first rotatable developing member and the second rotatable developing member face each other, a first duct wall configured to extend downstream, in the rotational direction of the second rotatable developing member, of the suction port, the first duct wall disposed to face a part of the second rotatable developing member with a gap therebetween, and a second duct wall disposed to face the first duct wall and configured to form a space between the second duct wall and the first duct wall through which the developer sucked from the suction port flows, the second duct wall being positioned on an outer side than the first duct wall with respect to a rotation center of the second rotatable developing member in a direction from the rotation center of the second rotatable developing member toward a position on an outer peripheral surface of the second rotatable developing member where an absolute value of a normal component of a magnetic flux density of the sixth magnetic pole becomes maximum. The rotational direction of the second rotatable developing member is opposite from the rotational direction of the first rotatable developing member at the position at which the first rotatable developing member and the second rotatable developing member face each other. The position on the outer peripheral surface of the second rotatable developing member where the absolute value of the normal component of the magnetic flux density of the sixth magnetic pole becomes maximum is positioned downstream of an edge of the first duct wall on the suction port side with respect to the rotational direction of the second rotatable developing member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to an embodiment.

FIG. 2 is a schematic cross-sectional view illustrating a developing apparatus according to the embodiment.

FIG. 3 is a view illustrating a magnetic pole arrangement of a first developing roller according to the embodiment.

FIG. 4 is a view illustrating a magnetic pole arrangement of a second developing roller according to the embodiment.

FIG. 5 is a view illustrating a magnetic pole arrangement of a peeling roller according to the embodiment.

FIG. 6 is an enlarged view illustrating a periphery of the second developing roller, the peeling roller, and a duct according to the embodiment.

FIG. 7 is a schematic cross-sectional view of a developing apparatus according to a conventional example.

FIG. 8 is an enlarged view of a circumference of a peeling roller illustrating a duct arrangement and a magnetic pole arrangement of a peeing roller according to Example 1.

FIG. 9 is an enlarged view of a circumference of a peeling roller illustrating a duct arrangement and a magnetic pole arrangement of a peeing roller according to Comparative Example 1.

FIG. 10 is an enlarged view of a circumference of a peeling roller illustrating a duct arrangement and a magnetic pole arrangement of a peeing roller according to Example 2.

FIG. 11 is a graph illustrating a distribution of FO of the peeling magnet near an edge of a first duct wall according to Examples 1, 3, and 4.

FIG. 12 is a schematic cross-sectional view of a developing apparatus according to Example 5.

FIG. 13 is a graph illustrating a distribution of Br near a peeling pole according to Example 5.

### DESCRIPTION OF THE EMBODIMENTS

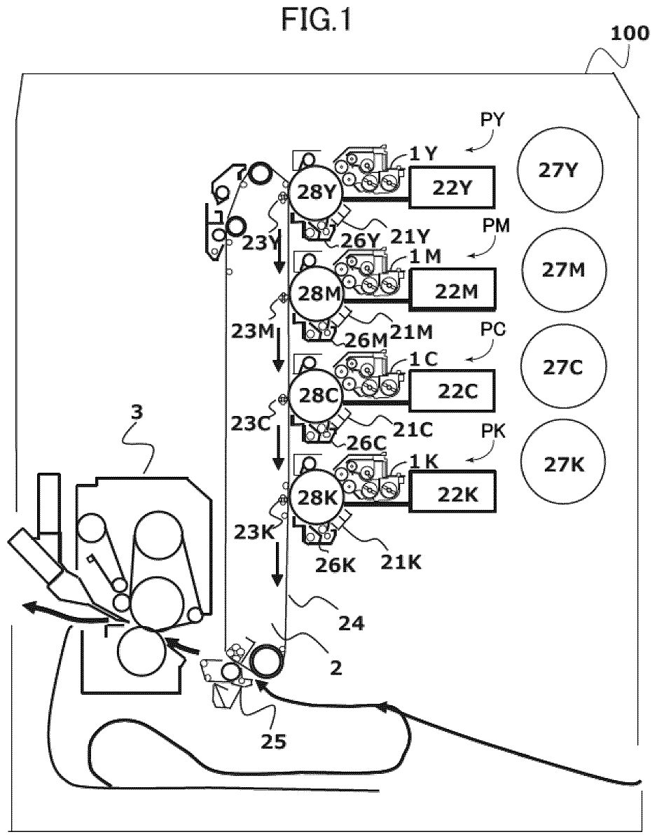

An embodiment will be described with reference to FIGS. 1 to 6. First, a schematic configuration of an image forming apparatus of the present embodiment will be described with reference to FIG. 1.

### Image Forming Apparatus

An image forming apparatus 100 is a full-color image forming apparatus, and in the present embodiment, for example, is a multi-function peripheral (MFP) having a copy function, a printer function, and a scan function. As illustrated in FIG. 1, the image forming apparatus 100 includes image forming units PY, PM, PC, and PK that perform image forming processes for toner images of four colors of yellow, magenta, cyan, and black, respectively, that are arranged in parallel. The image forming apparatus 100 according to the present embodiment has a document reading apparatus connected to an image forming apparatus body, i.e., apparatus body, or a host apparatus such as a personal computer connected in a communicatable manner to the apparatus body. Therefore, according to an image information received from the host apparatus, a four-color full-color image of yellow (Y), magenta (M), cyan (C), and black (K) may be formed on a recording material, such as recording paper, plastic sheets, and cloths, using an electrophotographic system.

The image forming units PY, PM, PC, and PK of the respective colors include primary chargers 21Y, 21M, 21C, and 21K, developing apparatuses 1Y, 1M, 1C, and 1K, exposure devices 22Y, 22M, 22C, and 22K, photosensitive drums 28Y, 28M, 28C, and 28K, and cleaning devices 26Y, 26M, 26C, and 26K. The image forming apparatus 100 includes a transfer device 2 and a fixing device 3. Since configurations of the image forming units PY, PM, PC, and PK of the respective colors are similar to each other, the image forming unit PY will be described below as a representative.

The photosensitive drum 28Y serving as an image bearing member is a photosensitive member including a photosensitive layer made of a resin such as a polycarbonate resin containing an organic photoconductor (OPC), and is configured to rotate at a predetermined speed. According to the present embodiment, a linear velocity of the surface of the photosensitive drum 28Y is set to 650 mm/s. The primary charger 21Y includes a corona discharge electrode disposed around the photosensitive drum 28Y, and charges the surface of the photosensitive drum 28Y with generated ions.

The exposure device 22Y incorporates a scanning optical device, and exposes the charged photosensitive drum 28Y based on image data to lower a potential of an exposed portion, thereby forming a charge pattern, i.e., electrostatic latent image, corresponding to the image data. The developing apparatus 1Y transfers a developer accommodated therein to the photosensitive drum 28Y to develop the electrostatic latent image formed on the photosensitive drum 28Y. The developer is formed by mixing a carrier and a toner corresponding to each color, and the electrostatic latent image is visualized by the toner.

The transfer device 2 includes primary transfer rollers 23Y, 23M, 23C, and 23K, an intermediate transfer belt 24, and a secondary transfer roller 25. The intermediate transfer belt 24 is wound around the primary transfer rollers 23Y, 23M, 23C, and 23K and a plurality of rollers, and is supported so as to be able to travel. The primary transfer rollers 23Y, 23M, 23C, and 23K serving as primary transfer members correspond to respective colors of yellow (Y), magenta (M), cyan (C), and black (K) in order from the top in FIG. 1. The secondary transfer roller 25 is disposed outside the intermediate transfer belt 24, and is configured to allow a recording material to pass between the secondary transfer roller 25 and the intermediate transfer belt 24.

The toner images of the respective colors formed on the photosensitive drums 28Y, 28M, 28C, and 28K are sequentially transferred, i.e., primarily transferred, onto the intermediate transfer belt 24 by the operation of a primary transfer bias applied to the primary transfer rollers 23Y, 23M, 23C, and 23K at a primary transfer portion, i.e., primary transfer nip, T1 where the intermediate transfer belt 24 and the photosensitive drums 28Y, 28M, 28C, and 28K abut on each other. For example, when forming a four-color full-color image, toner images are sequentially transferred, starting from the photosensitive drum 28Y, on the intermediate transfer belt 24, such that a toner image in which the respective colors of yellow, magenta, cyan, and black are layered in a superimposed manner is formed.

Meanwhile, a recording material S stored in a cassette 115 serving as a recording material accommodating portion is conveyed via a pickup roller 111 and a registration roller 112 toward the transfer device 2. The recording material S is conveyed at a synchronized timing with the toner image on the intermediate transfer belt 24 to a secondary transfer portion, i.e., nip portion, T2 where the intermediate transfer belt 24 and the secondary transfer roller 25 serving as a secondary transfer member abut on each other. The toner image formed on the intermediate transfer belt 24 is secondarily transferred onto the recording material S by the operation of a secondary transfer bias applied on the secondary transfer roller 25 at the secondary transfer portion T2. Pressure and heat are applied at the fixing device 3 to the recording material to which the toner image is transferred. As a result, the toner on the recording material is melted, and the color image is fixed to the recording material. Thereafter, the recording material S is discharged to the exterior of the apparatus.

When forming images on both sides of the recording material, the recording material S having passed through the fixing device 3 is conveyed to a reverse conveyance passage 113, where the recording material S is reversed, and the recording material S is then conveyed to the registration roller 112 by a conveyance roller 114, and a toner image is transferred to a back surface of the recording material S in a similar manner as described above at the secondary transfer portion T2. Then, the toner image is fixed to the back surface of the recording material S again at the fixing device 3.

Attached matter such as toner remaining on the photosensitive drums 28Y, 28M, 28C, and 28K after the primary transfer process is collected by the cleaning devices 26Y, 26M, 26C, and 26K. Thereby, the photosensitive drums 28Y, 28M, 28C, and 28K prepare for the subsequent image forming process. Further, attached matter such as toner remaining on the intermediate transfer belt 24 after the secondary transfer process is removed by an intermediate transfer belt cleaner 29.

Alternatively, the image forming apparatus 100 according to the present embodiment may use the image forming unit of a desired single color, such as black, or some of the image forming units among the four colors to form a single color or a multi-color image.

Developer storages 27Y, 27M, 27C, and 27K are respectively provided corresponding to the developing apparatuses 1Y, 1M, 1C, and 1K, and bottles accommodating developers corresponding to the respective colors of yellow, magenta, cyan, and black are replaceably loaded in the named order from the top. The developer storages 27Y, 27M, 27C, and 27K are configured to be able to convey, i.e., replenish, the developers to the developing apparatuses 1Y, 1M, 1C, and 1K corresponding to the colors of the accommodated developers.

For example, a weight ratio of the toner of the developer contained in the bottle is 80 to 95%, and a weight ratio of the toner of the developer in each of the developing apparatuses 1Y, 1M, 1C, and 1K is 5 to 10%. Therefore, once the toner is consumed to perform the development in the developing apparatuses 1Y, 1M, 1C, and 1K, the developer containing the toner is replenished to compensate for the amount of consumption, and the weight ratio of the toner of the developer in each of the developing apparatuses 1Y, 1M, 1C, and 1K is maintained constant.

### Developing Apparatus

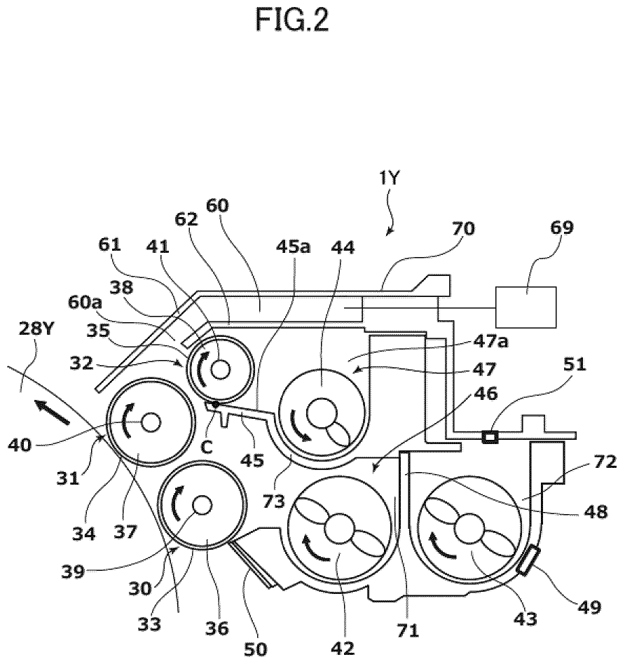

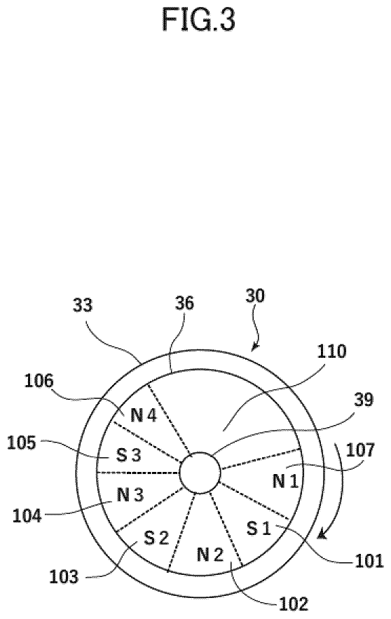

Next, the developing apparatuses 1Y, 1M, 1C, and 1K will be described in detail with reference to FIGS. 2 to 5. Since the configurations of the developing apparatuses 1Y, 1M, 1C, and 1K are the same, the developing apparatus 1Y will be described below as a representative. FIG. 2 is a conceptual view illustrating the developing apparatus 1Y illustrated in FIG. 1, and FIGS. 3, 4, and 5 are conceptual views illustrating magnetic pole configurations of a first developing magnet, i.e., first magnet, 36, a second developing magnet, i.e., second magnet, 37, and a peeling magnet, i.e., third magnet, 38 disposed in the developing apparatus 1Y.

As illustrated in FIG. 2, the developing apparatus 1Y includes a first developing roller 30, a second developing roller 31, a peeling roller 32, a developer supplying screw 42, a developer stirring screw 43, and a developer collecting screw 44, and these members are housed in a developing container 70. The developing container 70 accommodates a two-component developer containing a nonmagnetic toner and a magnetic carrier.

The first developing roller 30 is a developer bearing member that is rotationally driven, and is disposed at a position adjacent to the photosensitive drum 28Y such that a rotational axis thereof is substantially parallel to a rotational axis of the photosensitive drum 28Y. The first developing roller 30 includes a first developing sleeve (a third rotatable developing member) 33 that rotates, and a first developing magnet (a third magnet), i.e., fixed magnet, 36 that is provided non-rotatably inside the first developing sleeve 33 and attracts the developer to the surface of the first developing sleeve 33 by a magnetic force. Then, the first developing roller 30 attracts, i.e., carries, the developer from the developer supplying screw 42 based on the magnetic force, and develops the electrostatic latent image formed on the rotating photosensitive drum 28Y, i.e., on the image bearing member, with the developer.

Specifically, for example, a DC developing bias having a same polarity as a charging polarity of the primary charger 21Y, or a developing bias in which a DC voltage having a same polarity as the charging polarity of the primary charger 21Y is superposed to AC voltage, is applied to the first developing sleeve 33 and a second developing sleeve 34 described later of the developing apparatus 1Y. As a result, reversal development is performed in which a toner charged to the same polarity as the charging polarity of the primary charger 21Y is adhered to the electrostatic latent image formed on the photosensitive drum 28Y by the exposure device 22Y. In the present embodiment, a configuration is adopted in which a reversal development is performed where the charging polarity of the primary charger 21Y and the DC voltage of the developing bias are set to negative and a toner charged negatively is attached to the electrostatic latent image.

The first developing sleeve 33 is a nonmagnetic cylindrical member having an outer diameter of 25 mm (radius r1=12.5 mm), and is rotationally driven about a rotation shaft 39. A rotational direction of the first developing sleeve 33 is a clockwise direction as indicated by an arrow in FIG. 2, and is a direction opposite to a rotational direction of the photosensitive drum 28Y in the present embodiment. Therefore, the first developing sleeve 33 and the photosensitive drum 28Y rotate in the same direction, i.e., forward direction, at positions facing each other. That is, the first developing sleeve 33 is rotated such that the surface facing the photosensitive drum 28Y is moved from down to up in a vertical direction.

In the present embodiment, the linear velocity of the surface of the first developing sleeve 33 is set to be 1.0 times (=650 mm/s) the linear velocity of the surface of the photosensitive drum 28Y. Setting the ratio of linear velocity of the surface of the first developing sleeve 33 with respect to the linear velocity of the surface of the photosensitive drum 28Y to fall within approximately 1.0 times or more and 1.2 times or less is advantageous from the viewpoint of toner deterioration. Meanwhile, the amount of toner being supplied to the photosensitive drum 28Y may be reduced and the image developing property may be deteriorated, but since the present embodiment is equipped with two developing rollers 30 and 31, the amount of toner being supplied to the photosensitive drum 28Y may be maintained even if the ratio of linear velocity is suppressed.

The first developing magnet 36 is disposed inside the first developing sleeve 33, and has a plurality of magnetic poles 101 to 107, as illustrated in FIG. 3. A space that allows rotation of the first developing sleeve 33 is disposed between an inner periphery of the first developing sleeve 33 and an outer periphery of the first developing magnet 36.

The developer attracted to the first developing sleeve 33 is fed toward the photosensitive drum 28Y by a rotation operation of the first developing sleeve 33, thereby developing the latent image formed on the photosensitive drum 28Y. After the latent image formed on the photosensitive drum 28Y is developed, the developer on the first developing sleeve 33 is fed to the vicinity of the second developing roller 31 by the rotation operation of the first developing sleeve 33. Then, in the vicinity of the closest position of the first developing roller 30 and the second developing roller 31, the developer is peeled off from the first developing sleeve 33 by a magnetic field generated by the first developing magnet 36 within the first developing roller 30 and the second developing magnet 37 within the second developing roller 31, and is delivered onto the second developing sleeve 34. The first developing sleeve 33 and the second developing sleeve 34 are arranged with a gap of 3 mm therebetween at the closest portion.

The second developing roller 31 serving as a developing roller is a developer bearing member that is rotationally driven, is disposed downstream of the first developing roller 30 in the rotational direction of the photosensitive drum 28Y and positioned higher than a rotation center of the first developing roller 30 in the vertical direction, and receives the developer delivered from the first developing roller 30 by the magnetic force. Similar to the first developing roller 30, the second developing roller 31 is disposed at a position adjacent to the photosensitive drum 28Y such that a rotational axis thereof is substantially parallel to the rotational axis of the photosensitive drum 28Y. Therefore, the rotational axes of the second developing roller 31 and the first developing roller 30 are substantially parallel to each other.

Such a second developing roller 31 includes a second developing sleeve (a first rotatable developing member) 34 that rotates and the second developing magnet (a first magnet), i.e., fixed magnet, 37 that is provided non-rotatably inside the second developing sleeve 34 and attracts the developer to the surface of the second developing sleeve 34 by a magnetic force. Then, the second developing roller 31 receives the developer delivered from the first developing roller 30, i.e., the first developing sleeve 33, based on the magnetic force, attracts, i.e., carries, the developer, and develops the electrostatic latent image formed on the rotating photosensitive drum 28Y with the developer. The peeling roller 32 described below is positioned on a side of the second developing roller 31.

The second developing sleeve 34 is a nonmagnetic cylindrical member having an outer diameter of 25 mm (radius r2=12.5 mm), and is rotationally driven about a rotation shaft 40. A rotational direction of the second developing sleeve 34 is a clockwise direction, as indicated by an arrow in FIG. 2, and is a direction opposite to the rotational direction of the photosensitive drum 28Y in the present embodiment. Therefore, the second developing sleeve 34 and the photosensitive drum 28Y rotate in the same direction at positions facing each other, i.e., opposing portions. That is, the second developing sleeve 34 is rotated such that a surface facing the photosensitive drum 28Y moves from down to up in the vertical direction. Further, the second developing sleeve 34 and the first developing sleeve 33 rotate in opposite directions at positions facing each other. In the present embodiment, the linear velocity of the surface of the second developing sleeve 34 is set to be 1.2 times (=780 mm/s) the linear velocity of the surface of the photosensitive drum 28Y.

The second developing magnet 37 is disposed inside the second developing sleeve 34 and has a plurality of fan-shaped magnetic poles 201 to 207. A space that allows rotation of the second developing sleeve 34 is disposed between an inner periphery of the second developing sleeve 34 and an outer periphery of the second developing magnet 37.

The developer attracted to the second developing sleeve 34 is fed toward the photosensitive drum 28Y by a rotation operation of the second developing sleeve 34, thereby developing the latent image formed on the photosensitive drum 28Y. After the latent image formed on the photosensitive drum 28Y is developed, the developer remaining on the second developing sleeve 34 is fed to the vicinity of the peeling roller 32 by the rotation operation of the second developing sleeve 34. Then, in the vicinity of the closest positions of the second developing roller 31 and the peeling roller 32, the developer is delivered from the second developing sleeve 34 to a peeling sleeve 35 of the peeling roller 32 by a magnetic field generated by the second developing magnet 37 within the second developing roller 31 and the peeling magnet 38 within the peeling roller 32.

The peeling roller, i.e., collecting roller, 32 is disposed on a side opposite to the photosensitive drum 28Y with respect to a rotation center of the second developing sleeve 34, and peels, from the second developing roller 31, the developer after developing the electrostatic latent image on the photosensitive drum 28Y by the second developing roller 31. Specifically, the peeling roller 32 is a developer bearing member that is rotationally driven, and is disposed between the second developing roller 31 and the developer collecting screw 44 such that a rotation center thereof is positioned higher than a rotation center of the second developing roller 31.

The peeling roller 32 is disposed such that a rotational axis thereof is substantially parallel to the rotational axis of the second developing roller 31. The peeling roller 32 includes the peeling sleeve (a second rotatable developing member) 35 that rotates and the peeling magnet (a second magnet), i.e., fixed magnet, 38 that is provided non-rotatably inside the peeling sleeve 35 and attracts the developer to the surface of the peeling sleeve 35 by a magnetic force, and is configured to receive the developer delivered from the second developing roller 31 based on the magnetic force.

The peeling sleeve 35 is a nonmagnetic cylindrical member having an outer diameter of 18 mm (a radius of 9 mm), and is rotationally driven about a rotation shaft 41. A rotational direction of the peeling sleeve 35 is a clockwise direction as indicated by an arrow in FIG. 2, and is the same direction as the rotational direction of the second developing sleeve 34 in the present embodiment. Therefore, the peeling sleeve 35 and the second developing sleeve 34 rotate in the opposite direction at positions facing each other, i.e., opposing portions. That is, the peeling sleeve 35 is rotated such that the surface thereof moves in an opposite direction as the surface of the second developing sleeve 34 in the opposing portion that faces the second developing sleeve 34.

The peeling magnet 38 is disposed inside the peeling sleeve 35 and has a plurality of magnetic poles 301 to 305. A space that allows rotation of the peeling sleeve 35 is disposed between an inner periphery of the peeling sleeve 35 and an outer periphery of the peeling magnet 38.

The developer attracted to the peeling sleeve 35 is fed downstream in the rotational direction by the rotation operation of the peeling sleeve 35, is peeled off from the peeling sleeve 35 by the peeling magnet 38 within the peeling roller 32 at a position close to the developer collecting screw 44, and falls toward a guide member 45 positioned lower in the vertical direction by its own weight. Then, the developer falling onto the guide member 45 is guided by its own weight toward the developer collecting screw 44.

The guide member 45 and the developer collecting screw 44 constitute a developer collecting portion 47 serving as a collecting portion that collects the developer peeled off from the peeling sleeve 35 of the peeling roller 32. In the developer collecting portion 47, the developer collecting screw 44 is positioned lower than the rotation center of the peeling roller 32 in the vertical direction, and conveys the developer delivered, i.e., collected, from the peeling roller 32 while stirring the developer.

The guide member 45 serving as a guide portion is disposed below the rotation center of the peeling roller 32 in the vertical direction, and arranged such that a position on the guide member 45 where the guide member 45 and the peeling roller 32 are closest, i.e., closest position C, is higher than a center of the rotation shaft 40, i.e., rotation center, of the second developing roller 31 in the vertical direction. The guide member 45 guides the developer peeled off by the peeling roller 32 toward the developer collecting screw 44. Such a guide member 45 has an inclined surface 45a on which the developer slides down by its own weight in order to more reliably guide the peeled developer toward the developer collecting screw 44. The inclined surface 45a is inclined with respect to a horizontal direction such that a portion adjacent to the developer collecting screw 44 is positioned lower than the position below the peeling roller 32.

The developer collecting screw 44 serving as a collecting member and a conveyance portion conveys the collected developer to a developer circulating portion 46 described below. That is, the developer collecting screw 44 is a screw conveyance member used to convey the developer sliding down the inclined surface of the guide member 45 and collected in one direction while stirring the developer.

The developer circulating portion 46 is a supply portion for supplying the developer to the first developing roller 30, and the developer circulating portion 46 includes a regulating member 50, the developer supplying screw 42, and the developer stirring screw 43. In the developer circulating portion 46, the developer is supplied to the first developing roller 30 while being fed in the substantially horizontal direction and stirred by the developer supplying screw 42 and the developer stirring screw 43. As described above, the developer collected by the developer collecting portion 47 falls by its own weight and is introduced into the developer circulating portion 46. That is, the developer circulating portion 46 is positioned lower than the developer collecting portion 47 with respect to the vertical direction.

The developer supplying screw (a first conveyance portion) 42, the developer stirring screw (a third conveyance portion) 43, and the developer collecting screw (a second conveyance portion) 44 are screw conveyance members that convey the developer in one direction while stirring the developer, and the developer supplying screw 42 and the developer stirring screw 43 are positioned lower than the rotation center of the developer collecting screw 44 in the vertical direction. In addition, the developer supplying screw 42, the developer stirring screw 43, and the developer collecting screw 44 are disposed such that rotation axes thereof are substantially parallel to each other. The rotation axis of each screw is substantially parallel to the rotation axis of the first developing roller 30.

The developer supplying screw 42 is positioned between the first developing roller 30 and the developer stirring screw 43, and a partition wall 48 of the developing container 70 is disposed between the developer supplying screw 42 and the developer stirring screw 43. The partition wall 48 of the developing container 70 extends in a rotation axis direction of the developer supplying screw 42 and the developer stirring screw 43. The partition wall 48 has a communication port (not illustrated) for communication between a first conveyance path (a first chamber) 71 through which the developer is fed by the developer supplying screw 42 and a second conveyance path (a third chamber) 72 through which the developer is fed by the developer stirring screw 43.

The developer stirred by the developer collecting screw 44 passes through a communication port (not illustrated) formed in a partition wall 73 of the developing container 70 between a developer collecting chamber (a second chamber) 47a in which the developer collecting screw 44 is disposed and the first conveyance path (the first chamber) 71 in which the developer supplying screw 42 is disposed, and falls toward the developer supplying screw 42 by its own weight. The guide member 45 described above is formed integrally with the partition wall 73, and the developer collecting screw 44 is disposed above the partition wall 73.

A position of the communication port through which the developer stirred by the developer collecting screw 44 falls by its own weight and is introduced into the developer circulating portion 46 is preferably disposed to avoid a region where the developer is supplied toward the first developing roller 30, i.e., an intermediate portion of the developer supplying screw 42 in the rotation axis direction. In the present embodiment, it is assumed that the position of the communication port is a position within a range of a downstream end portion, i.e., terminal end portion, of the first conveyance path 71, in which the developer supplying screw 42 is disposed, in a developer conveyance direction.

The developer conveyance directions of the developer supplying screw 42 and the developer stirring screw 43 are opposite to each other. A start end side, i.e., an upstream end side in the developer conveyance direction, and a terminal end side, i.e., a downstream end side in the developer conveyance direction, of the first conveyance path 71 in which the developer supplying screw 42 is disposed communicate with a terminal end side and a start end side of the second conveyance path 72 in which the developer stirring screw 43 is disposed via the communication port provided in the partition wall 48. Therefore, the developer circulates in a rotational direction of the developer supplying screw 42 and the developer stirring screw 43 indicated by arrows in FIG. 2 and in the substantially horizontal direction inside the developing container 70, and a part of the developer is supplied toward the first developing roller 30.

A developer replenishment port 51 (refer to FIG. 2) is provided above the developer stirring screw 43 in the developing container 70, and is connected to the developer storage 27Y (refer to FIG. 1). The developer replenishment port 51 is configured to be able to replenish the developer contained in a bottle loaded in the developer storage 27Y to the second conveyance path 72 in which the developer stirring screw 43 is disposed.

As described above, since the weight ratio of the toner of the developer contained in the bottle of the developer storage 27Y is higher than the weight ratio of the toner of the developer in the developing apparatus 1Y, the weight ratio of the toner of the developer in the developing apparatus 1 can be maintained constant by adjusting the developer being replenished to the developer stirring screw 43.

A toner density detection sensor 49 (refer to FIG. 2) is provided to detect a toner density in the developer contained in the developer circulating portion 46. The toner density detection sensor 49 is a sensor that detects magnetic permeability of the developer. Since the toner density corresponds to the amount of toner consumption in the developing apparatus 1Y, the toner density is used for controlling developer replenishment from the developer storage 27Y. For example, when it is detected that the toner density is lower than a predetermined value, the developer is replenished from the developer storage 27Y. Since the magnetic permeability of the developer changes depending on the toner density, the toner density can be detected using the magnetic permeability.

The regulating member 50 is disposed adjacent to the first developing roller 30, and is used to regulate the amount of developer supplied from the developer circulating portion 46 to the first developing roller 30. For example, the regulating member 50 can be configured to regulate the amount of developer attracted to the first developing roller 30 based on a gap between the surface of the first developing sleeve 33 of the first developing roller 30 and an end portion of the regulating member 50.

In a developer circulation path in the developing container 70, the developer is fed in the substantially horizontal direction while being stirred in the developer circulating portion 46, is then supplied to the first developing roller 30, and is delivered from the first developing roller 30 to the second developing roller 31 positioned higher than the first developing roller 30 based on the magnetic force. Then, the developer is delivered again from the second developing roller 31 to the peeling roller 32 positioned on the side surface of the second developing roller 31 based on the magnetic force, is then peeled off from the peeling roller 32 by the peeling magnet 38 within the peeling roller 32, is further collected by the developer collecting portion 47, and is introduced again into the developer circulating portion 46.

As described above, in the present embodiment, a two-component developing system is used as a developing system, and a mixture of a nonmagnetic toner having a negative charging polarity and a magnetic carrier is used as the developer. The nonmagnetic toner is charged negatively by frictional electrification with the magnetic carrier, and the magnetic carrier is charged positively. The nonmagnetic toner is obtained by incorporating a colorant and a wax component in a resin such as a polyester resin or a styrene acrylic resin, pulverizing or polymerizing the resin into powder, and adding fine powder of titanium oxide, silica, or the like to the surface. The magnetic carrier is obtained by applying resin coating to a surface layer of a core formed of ferrite particles or resin particles kneaded with magnetic powder. A toner density, i.e., weight ratio of the toner contained in the developer, in the developer in an initial state is 8% in the present embodiment.

Note that the magnetic carrier preferably has a magnetization amount per unit weight of 40 to 80 Am²/kg or less in an applied magnetic field of 1000 oersted. When the magnetization amount of the magnetic carrier is reduced, there is an effect of suppressing scavenging by a magnetic brush, but adhesion of the magnetic carrier to the nonmagnetic sleeve by a magnetic field generating portion becomes difficult, and image defects such as adhesion of the magnetic carrier to the photosensitive drum may occur. When the magnetization amount of the magnetic carrier is larger than the above range, image defects may occur due to the pressure of the magnetic brush as described above. In the present embodiment, a magnetic carrier whose magnetization amount per unit weight is 63 Am²/kg is used. The magnetization amount of the magnetic carrier was measured using a vibrating magnetic field-type automatic magnetic characteristic recording apparatus BHV-30 manufactured by RIKEN Denshi Co., Ltd. For a magnetic characteristic value of the magnetic carrier, an external magnetic field of 1000 oersted is created, and a strength of magnetization at that time is obtained. The magnetic carrier is packed in a cylindrical plastic container so as to be sufficiently dense. In this state, a magnetization moment is measured, the actual weight when a sample is put is measured, and the strength of magnetization (Am²/kg) is obtained.

A true specific gravity of the magnetic carrier is determined by a dry automatic density type AccuPyc 1330 manufactured by Shimadzu Corporation. In the present embodiment, a magnetic carrier having a true specific gravity, i.e., density, of 4.6 (g/cm³) was used. In addition, a magnetic carrier having a weight average diameter of 35 μm (radius b=17.5 μm) was used.

In general, in the two-component development method using a toner and a carrier, both the toner and the carrier are charged to predetermined polarities by being brought into frictional contact with each other, and thus has a feature that stress received by the toner is less than that of a one-component developing system using a one-component developer. On the other hand, the long-term use increases soiling, i.e., spent, attached to the surface of the carrier, and thus an ability to charge the toner gradually decreases. As a result, issues such as fogging and toner scattering occur. In order to prolong the life of a two-component developing apparatus, it is conceivable to increase the amount of carriers contained in the developing apparatus, but such a configuration is not desirable, since the size of the developing apparatus may be increased.

In order to solve the above issue related to the two-component developer, an auto carrier refresh (ACR) method is adopted in the present embodiment. The ACR method is a method of suppressing an increase in deteriorated carrier by replenishing a new developer from the developer storage 27Y into the developing apparatus 1Y little by little and discharging the developer with deteriorated charging performance little by little from a discharge port (not illustrated) of the developing apparatus 1Y. As a result, the deteriorated carrier in the developing apparatus 1Y is gradually replaced with the new carrier, and the charging performance of the carrier in the developing apparatus 1Y can be kept substantially constant.

In the developing apparatus 1Y of the present embodiment configured as described above, the developer in the first conveyance path 71 is supplied via the developer supplying screw 42 to the first developing sleeve 33, and a predetermined amount of developer supplied to the first developing sleeve 33 is borne on the first developing sleeve 33 by the magnetic field generated by the first developing magnet 36, and forms a developer accumulation. The two-component developer on the first developing sleeve 33 passes through the developer accumulation by the rotation of the first developing sleeve 33, forms a thin layer coating on the surface of the first developing sleeve 33 by the regulating member 50, and is carried to a development region facing the photosensitive drum 28Y. In the development region, the developer on the first developing sleeve 33 is napped and a magnetic brush is formed.

In a first development region where the first developing sleeve 33 and the photosensitive drum 28Y face each other, the electrostatic latent image formed on the photosensitive drum 28Y is developed by developing bias applied to the first developing sleeve 33. In the present embodiment, the developing bias applied to the first developing sleeve 33 has a waveform in which both an AC electric field and a DC electric field are applied, but alternatively, the developing bias may only have a DC electric field.

The two-component developer is used for a developing process in the first development region, and then delivered to the second developing sleeve 34 at a position close to the second developing sleeve 34, thereafter fed to a second development region where the second developing sleeve 34 and the photosensitive drum 28Y face each other. In the second development region, a same developing bias as that applied in the first development region is applied, and toner that is insufficient with respect to the potential of the electrostatic latent image on the photosensitive drum 28Y is supplemented and developed, and toner that has been developed excessively is collected to prepare a uniform toner image. A bias having different waveforms may be applied as the developing bias applied to the first developing sleeve 33 and the developing bias applied to the second developing sleeve 34.

The developer having passed through the second development region is peeled off in a peeing magnetic field area formed by the second developing magnet 37 included in the second developing sleeve 34. The developer peeled off from the second developing sleeve 34 is attracted onto the surface of the peeling sleeve 35 by the magnetic field formed by the peeling magnet 38 included in the peeling sleeve 35 of the peeling roller 32, and conveyed along the rotational direction of the peeling sleeve 35. Then, the developer is detached from the surface of the peeling sleeve 35 by the peeing magnetic field formed by the peeling magnet 38, and is collected to the developer collecting portion 47.

### Magnetic Pole of Each Magnet

Next, the magnetic pole configurations of the first developing magnet 36, the second developing magnet 37, and peeing magnet 38 within the first developing roller 30, the second developing roller 31, and the peeling roller 32 illustrated in FIGS. 3, 4, and 5 will be described.

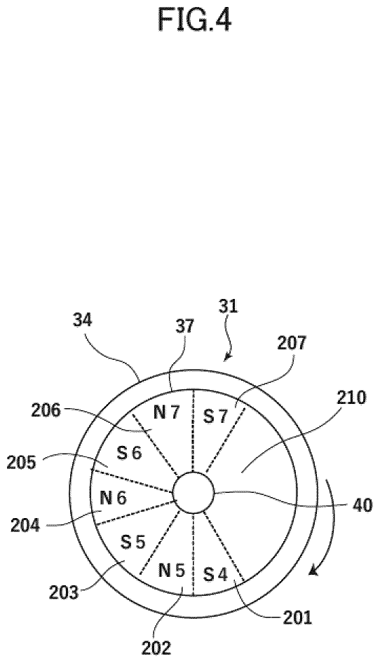

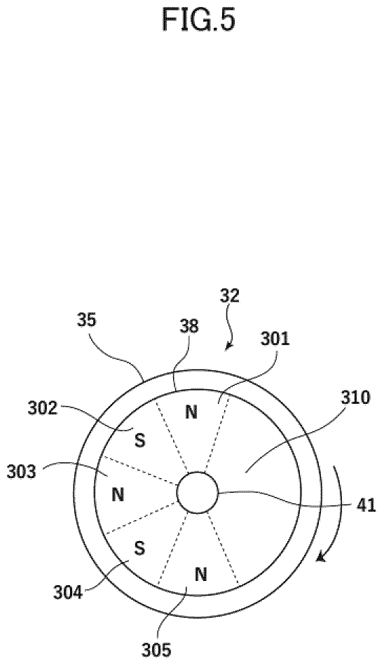

As illustrated in FIG. 3, the first developing magnet 36 within the first developing roller 30 has the plurality of magnetic poles 101 (S1), 102 (N2), 103 (S2), 104 (N3), 105 (S3), 106 (N4), and 107 (N1), wherein S and N indicate whether the magnetic pole is an S pole or an N pole, and the numerals are assigned for distinguishment from other magnetic poles. According to the present embodiment, the first developing magnet 36 includes a total of seven magnetic poles. The same applies to FIGS. 4 and 5. Among the magnetic poles, the magnetic pole 106 is a delivery pole for delivering the developer from the first developing roller 30 to the second developing roller 31. The magnetic poles 101 to 107 are arranged in number order in the rotational direction of the first developing sleeve 33.

The magnetic pole 106 is a magnetic pole for delivering the developer from the first developing sleeve 33 to the second developing sleeve 34 by a magnetic field generated in cooperation with the second developing magnet 37 of the second developing roller 31, and hereinafter, may be referred to as the delivery pole 106. The magnetic pole 107 is an N pole, and is used to attract the developer supplied from the developer supplying screw 42 onto the first developing sleeve 33. The magnetic poles 101, 102, 103, 104, and 105 are an S pole, an N pole, an S pole, an N pole, and an S pole, respectively, and are used to feed the developer attracted by the magnetic pole 107 upward as the first developing sleeve 33 rotates. The magnetic pole 106 is an N pole, and delivers the developer from the first developing sleeve 33 to the second developing sleeve 34 facing the first developing sleeve 33 by a magnetic field generated in cooperation with the magnetic pole 201 in the second developing magnet 37 within the second developing roller 31 as described above.

In the present embodiment, a low magnetic force portion 110 having a magnetic force lower than that of the magnetic pole 106 is formed by a repulsive magnetic field generated in cooperation between the magnetic pole 106 and the magnetic pole 107 disposed downstream of the magnetic pole 106 in the rotational direction of the first developing sleeve 33 and having the same magnetic polarity as the magnetic pole 106. The low magnetic force portion 110 promotes delivery of the developer from the first developing sleeve 33 to the second developing sleeve 34. Note that the low magnetic force portion 110 has almost no magnetic force in the present embodiment, but may have a low magnetic force, and for example, may be a magnetic pole having a magnetic force, i.e., absolute value of a normal component Br of the magnetic flux density, of 10 mT or less, or even 5 mT or less. The same applies to a low magnetic force portion 210 of the second developing magnet 37 illustrated in FIG. 4 and a low magnetic force portion 310 of the peeling magnet 38 illustrated in FIG. 5.

As illustrated in FIG. 4, the second developing magnet 37 within the second developing roller 31 has the plurality of magnetic poles 201 (S4), 202 (N5), 203 (S5), 204 (N6), 205 (S6), 206 (N7), and 207 (S7), a total of seven magnetic poles. The magnetic pole 201 is a receiving pole for the second developing roller 31 to receive the developer from the first developing roller 30. The magnetic poles 201 to 207 are arranged in number order in the rotational direction of the second developing sleeve 34.

The magnetic pole 201 is a magnetic pole for attracting the developer from the first developing sleeve 33 to the second developing sleeve 34 by a magnetic field generated in cooperation with the magnetic pole 107 of the first developing magnet 36 of the first developing roller 30, and hereinafter, may be referred to as the receiving pole 201. The magnetic pole 207 is a magnetic pole for delivering the developer from the second developing sleeve 34 to the peeling sleeve 35 by a magnetic field generated in cooperation with the peeling magnet 38 of the peeling roller 32, and hereinafter, may be referred to as the delivery pole 207.

Further, the receiving pole 201 is an S pole having a magnetic polarity different from that of the magnetic pole 106, and is used to attract the developer from the first developing roller 30, i.e., first developing sleeve 33, onto the second developing sleeve 34 as described above. The magnetic poles 202, 203, 204, 205, and 206 are an N pole, an S pole, an N pole, an S pole, and an N pole, respectively, and are used to feed the developer attracted by the magnetic pole 201 upward as the second developing sleeve 34 rotates. The magnetic pole 207 serving as a delivery pole is an S pole, and delivers the developer having passed through a development region between the magnetic pole 203 and the photosensitive drum 28Y corresponding to the magnetic pole 203 from the second developing sleeve 34 to the peeling sleeve 35 facing the second developing sleeve 34 by a magnetic field generated in cooperation with the magnetic pole 303 of the peeling magnet 38 within the peeling roller 32.

In the present embodiment, the low magnetic force portion 210 having a magnetic force lower than that of the magnetic pole 207 is formed by a repulsive magnetic field generated in cooperation between the magnetic pole 201 and the magnetic pole 207 disposed upstream of the magnetic pole 201 in the rotational direction of the second developing sleeve 34 and having the same magnetic polarity as the magnetic pole 201. The low magnetic force portion 210 promotes delivery of the developer from the first developing sleeve 33 to the second developing sleeve 34. In addition, the low magnetic force portion 210 can prevent the developer from being attracted to the closest portions of the first developing sleeve 33 and the second developing sleeve 34, so that a pressure applied to the developer can be suppressed.

As illustrated in FIG. 5, the peeling magnet 38 within the peeling roller 32 has the plurality of magnetic poles 301 (N8), 302 (S8), 303 (N9), 304 (S9), and 305 (N10), a total of five magnetic poles. The magnetic poles 301 to 305 are arranged in number order in the rotational direction of the peeling sleeve 35.

The magnetic pole 303 serving as a receiving pole is a magnetic pole for attracting the developer from the second developing sleeve 34 to the peeling sleeve 35 by the magnetic field generated in cooperation with the magnetic pole 207 of the second developing magnet 37 of the second developing roller 31, and hereinafter, may be referred to as the receiving pole 303. The magnetic pole 303 is an N pole that is of different polarity as the magnetic pole 207, and is used to attract the developer peeled off from the second developing sleeve 34 to the peeling sleeve 35 as described above. The magnetic poles 301, 302, and 304 are an N pole, an S pole, and an S pole, respectively, and are used to feed the developer on the peeling sleeve 35 as the peeling sleeve 35 rotates. In particular, the magnetic pole 302 is used to feed the developer attracted by the magnetic pole 303 upward as the peeling sleeve 35 rotates. Hereafter, the magnetic pole 302 may be referred to as the feeding pole 302. The magnetic pole 301 is an N pole, and is a peeling pole used to peel off the developer attracted to the peeling sleeve 35 from the peeling sleeve 35 by a repulsive magnetic field generated in cooperation with the magnetic pole 305 having the same magnetic polarity, and hereafter, it may be referred to as the peeling pole 301. The low magnetic force portion 310 having a magnetic force lower than that of the magnetic pole 301 is formed between the magnetic pole 301 and the magnetic pole 305.

### Duct

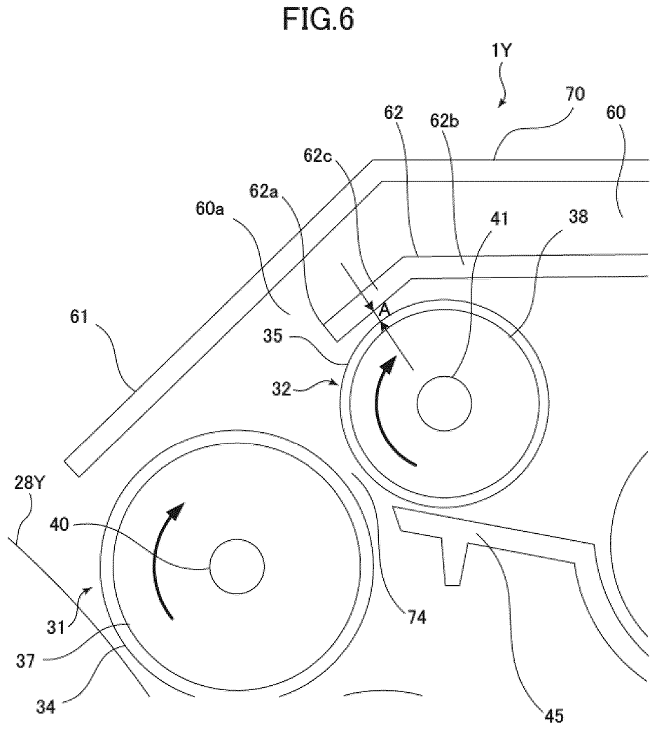

Next, a duct 60, which is a suction cleaning configuration for cleaning scattered toner generated at the second developing roller 31 and the peeling roller 32, will be described. FIG. 6 is a cross-sectional view illustrating an arrangement of the second developing roller 31, the peeling roller 32, and the duct, i.e., scattered toner collecting duct, 60 according to the present embodiment. The developing apparatus 1Y is equipped with the duct 60 including a first duct wall 62 and a second duct wall 61, and an air suction device 69 (refer to FIG. 2).

The first duct wall 62 covers a part of an inner space of the developing container 70 in which the first developing roller 30, the second developing roller 31, and the peeling roller 32 are disposed and in which the developer is stored, and prevents scattering of the developer from the inner space to the exterior. In the present embodiment, the first duct wall 62 covers an upper area of the peeling roller 32 and the developer collecting portion 47. Specifically, the first duct wall 62 includes a first wall portion 62b that is positioned above a peak of the peeling roller 32 in the vertical direction, and a second wall portion 62c that is extended upstream of the first wall portion 62b in the rotational direction of the peeling sleeve 35, and is positioned closer to the peeling roller 32 than the first wall portion 62b. That is, in the present embodiment, the first duct wall 62 is disposed to extend upstream in the rotational direction of the peeling sleeve 35 from the position above the peeling roller 32, and is bent diagonally downward in midway. Further, the edge of the second wall portion 62c opposite to the first wall portion 62b is an edge 62a of the first duct wall 62 on a suction port 60a side.

As described, the first duct wall 62 covers an upper portion of a part of the inner space of the developing container 70, and the second duct wall 61 is disposed on an outer side of the first duct wall 62 with respect to the rotation center of the peeling roller 32. In the present embodiment, the second duct wall 61 constitutes a part of an outer wall of the developing container 70, but it may be independent from the outer wall of the developing container 70. The second duct wall 61 is extended above the second developing roller 31, the edge thereof facing the photosensitive drum 28Y with a gap therebetween, and covers the upper portion of the second developing roller 31. Specifically, the second duct wall 61 is extended toward the second developing roller 31 side, i.e., developing roller side, than the edge 62a of the first duct wall 62 on the suction port 60a side. In the present embodiment, the second duct wall 61 is extended from above the first duct wall 62 in the vertical direction to a position facing the second developing roller 31.

Further, the suction port 60a of the duct 60 constituted of the first duct wall 62 and the second duct wall 61 is provided above the second developing roller 31. Specifically, the suction port 60a is an opening portion on a first end side of the duct 60 formed between the edge 62a of the first duct wall 62 and a part of the second duct wall 61. The suction port 60a is positioned downstream of an opposing portion 74 at which the second developing roller 31 and the peeling roller 32 face each other with respect to the rotational direction of the peeling roller 32.

On a second end side of the duct 60, the ducts of developing apparatuses for the respective colors are merged and connected to the air suction device 69. The air suction device 69 is a fan, for example, and by driving the air suction device 69, the developer scattered inside the developer container during developing operation is sucked through the suction port 60a via the duct 60. Thereby, the developer scattered to the exterior from the inner side of the developing container 70 may be reduced. When executing the image forming operation, the air suction device 69 is activated to perform suction of the developer being scattered. The suction operation is performed at all times during forming of image.

As illustrated in FIG. 6, the first duct wall 62 is arranged along the peeling roller 32. That is, the first duct wall 62 extends downstream of the peeling sleeve 35 in the rotational direction from the suction port 60a, and is arranged to face a part of the peeling roller 32 with a gap therebetween. Further, the first duct wall 62 is extended further from the position facing the peeling roller 32 to cover the upper area of the developer collecting portion 47. Therefore, the suction passage of the duct 60 is disposed on an opposite side of the peeling roller 32 interposing the first duct wall 62. In the present embodiment, a closest distance A between the peeling roller 32 and the first duct wall 62 is set to 1.5 mm.

The closest distance A is preferably within a range of 0.5 mm or more and 20 mm or less from the viewpoint of carrier collection in the duct 60 and retention of developer. In the present embodiment, the closest distance A between the second wall portion 62c of the first duct wall 62 and the peeling roller 32 is preferably set to 0.5 mm or more and 20 mm or less. If the closest distance A is large, the carrier is easily collected by the duct 60, and the duct 60 may be clogged easily by the carrier. Further, if the closest distance A is small, the developer may be retained, and the developer may not be easily carried by the peeling roller 32. In such a case, reverse flow of the developer may occurs, and by the developer returning toward the opposing portion 74, the co-rotation of developer on the second developing roller 31 may occur, which may lead to image defects. Therefore, it is preferable to set the closest distance A between the peeling roller 32 and the duct 60 to 0.5 mm or more and 20 mm or less.

### Conventional Example

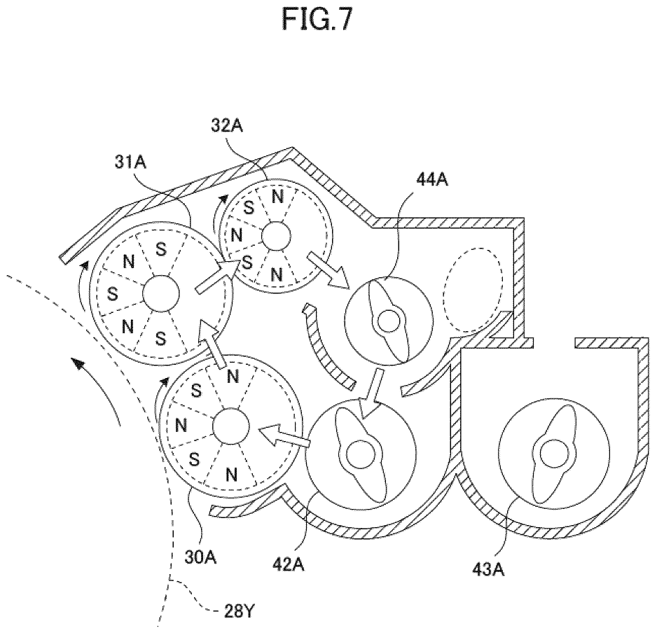

FIG. 7 illustrates a configuration of a developing apparatus according to a conventional example disclosed in Japanese Patent Application Laid-Open Publication No. 2018-124338. According to the conventional example, similar to the present embodiment, the developing apparatus includes a first developing roller 30A, a second developing roller 31A, a peeling roller 32A, a developer supplying screw 42A, a developer stirring screw 43A, and a developer collecting screw 44A. The first developing roller 30A, the second developing roller 31A, and the peeling roller 32A are respectively rotated in an arrow direction. However, the conventional example is not provided with the duct 60 for sucking the developer as according to the present embodiment. Therefore, the developer scattered in the developing container may be scattered to the exterior of the developing container. Then, the inner side of the image forming apparatus 100 may be soiled by the developer, or the output image may be soiled.

### Suction Cleaning of Scattered Toner and Clogging of Scattered Carrier

Next, a relationship between suction of scattered toner by the duct 60 and clogging of scattered carrier in the duct 60 will be described with reference to FIG. 6. In the present embodiment, as described above, the developer inside the developing apparatus 1Y is moved from the surface of the first developing sleeve 33 of the first developing roller 30 to the surface of the second developing sleeve 34 of the second developing roller 31, and thereafter, transferred to the surface of the peeling sleeve 35 of the peeling roller 32. The processing speed of the image forming apparatuses is increasing, and along therewith, the rotating speeds of the first developing roller 30, the second developing roller 31, and the peeling roller 32 are also increasing. Therefore, while the developer is carried on the respective sleeves, in a case where the napping of the magnetic brush is collapsed between magnetic poles, the toner and the carrier may be easily detached from the sleeves and scattered. Therefore, in the present embodiment, as a countermeasure against toner scattering, the duct 60 is disposed above the second developing roller 31 and the peeling roller 32, as described above. Then, the scattered toner is collected by the duct 60.

Further, airflow occurs by the second developing sleeve 34 and the peeling sleeve 35 that are rotated at high speed as described above, and the carrier that has been detached by centrifugal force may be scattered by the airflow. The airflow flows along the rotational direction of the respective sleeves, and the airflow near the peeling sleeve 35 flows along the rotational direction of the peeling sleeve 35. The scattered carrier moves along with the airflow and is sucked into the duct 60. The carrier sucked into the duct 60 causes clogging of the duct 60, and causes deterioration of collection efficiency of scattered toner. Therefore, it is necessary to suppress the carrier from being collected into the duct 60.

### Example 1

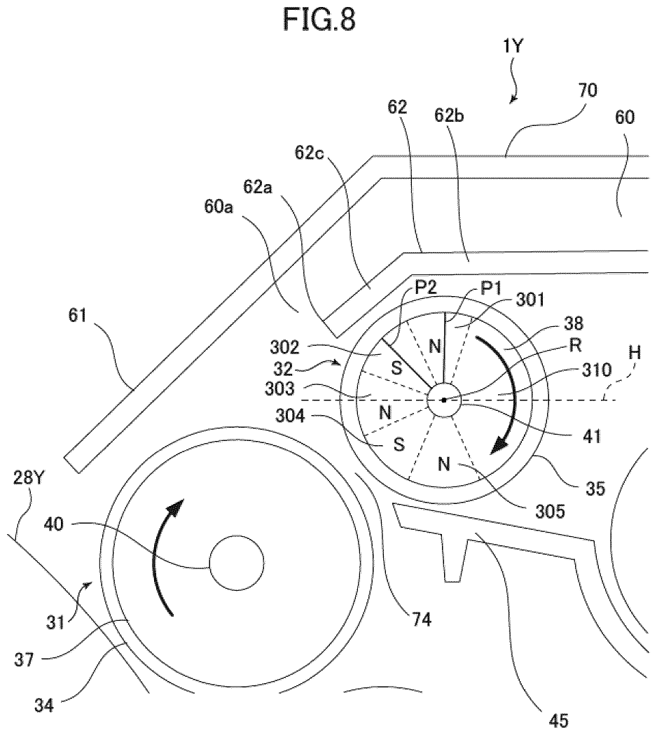

Example 1, which is one example of a configuration for suppressing scattering of carrier as described above in the configuration of the present embodiment will be described with reference to FIG. 8. In Example 1, a relationship between the position of the edge 62a of the first duct wall 62, which is the end portion of the duct 60 on the suction port 60a side, and the magnetic poles of the peeling magnet disposed inside the peeling roller 32 is defined as illustrated in FIG. 8.

That is, in the present embodiment, as illustrated in FIG. 8, a peak position, i.e., pole position, P1, which is a position of a maximum value of a normal component of a magnetic flux density of the peeling pole 301 on the peeling sleeve 35, is positioned downstream of the edge 62a of the first duct wall 62 on the suction port side in the rotational direction of the peeling sleeve 35. Further, the peak position P1 of the peeling pole 301 is positioned at a position facing the first duct wall 62. According to the present embodiment, the entirety of the peeling pole 301 is positioned downstream of the edge 62a in the rotational direction of the peeling sleeve 35, and faces the first duct wall 62.

As described, by positioning the peak position P1 of the peeling pole 301 downstream of the edge 62a of the first duct wall 62 in the rotational direction of the peeling sleeve 35, the developer carried on the peeling sleeve 35 is peeled off from the peeling roller 32 downstream of the suction port 60a in the rotational direction of the peeling sleeve 35. Therefore, the developer peeled off from the peeling roller 32 will not be sucked easily into the duct 60, and the carrier scattered by the peeling off of the developer may be suppressed from being collected into the duct 60.

According to the present embodiment, the feeding pole 302, which is a magnetic pole adjacent to the peeling pole 301 downstream of the receiving pole 303 and upstream of the peeling pole 301 with respect to the rotational direction of the peeling sleeve 35, also has a peak position P2 positioned downstream of the edge 62a. That is, the peak position, i.e., pole position, P2, which is a position of a maximum value of a normal component of a magnetic flux density of the feeding pole 302 on the peeling sleeve 35, is positioned downstream of the edge 62a of the first duct wall 62 on the suction port side in the rotational direction of the peeling sleeve 35.

The feeding pole 302 causes less scattering of carrier from the peeling roller 32 compared to the peeling pole 301, but scattering of carrier occurs at a napping collapse position which is positioned downstream of the feeding pole 302, and if the scattered carrier is caught in the airflow of the duct 60, the carrier will be collected into the duct 60. Therefore, according to the present embodiment, the peak position P2 of the feeding pole 302 is positioned downstream of the edge 62a of the first duct wall 62, such that the collecting of carrier by the duct 60 can be suppressed more efficiently.

### Comparative Example 1

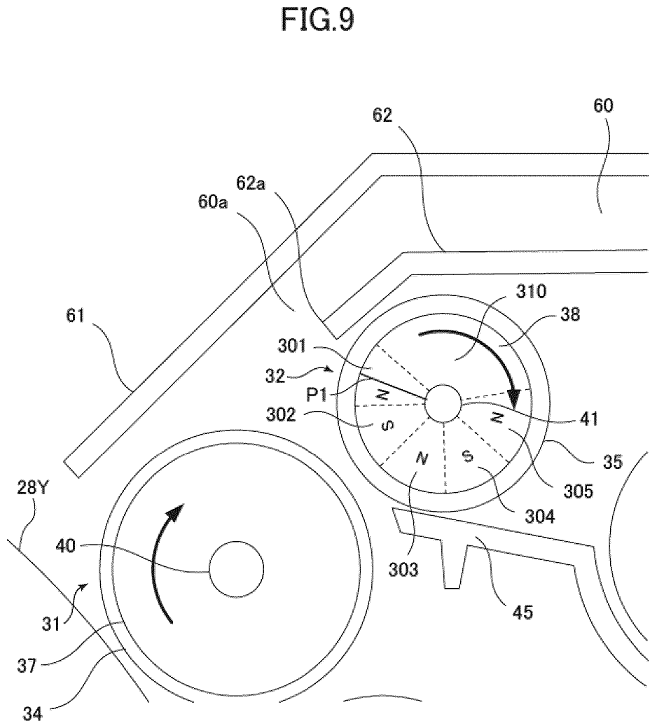

FIG. 9 illustrates a configuration of a Comparative Example 1. In Comparative Example 1, the peeling magnet 38 is rotated upstream in the rotational direction with respect to the configuration of Example 1 illustrated in FIG. 8, and the position of the peak position P1 of the peeling pole 301 is displaced from that of Example 1. That is, in the configuration of the Comparative Example 1, the peak position P1 of the peeling pole 301 is positioned upstream of the edge 62a of the first duct wall 62 on the suction port side in the rotational direction of the peeling sleeve 35.

In Comparative Example 1, the developer borne on the peeling sleeve 35 is peeled off from the peeling roller 32 upstream of the suction port 60a in the rotational direction of the peeling sleeve 35. Therefore, the developer peeled off from the peeling roller 32 is easily sucked into the duct 60, and the carrier scattered by the peeling of the developer is easily collected into the duct 60. Therefore, clogging of carrier in the duct 60 may easily occur, and when clogging of carrier occurs, the ability of the duct 60 to suck in scattered toner is deteriorated, and the scattering of toner may not be suppressed sufficiently.

In the Comparative Example 1 illustrated in FIG. 9, the peak position P1 of the peeling pole 301 is positioned upstream of the edge 62a of the first duct wall 62 by rotating the peeling magnet 38, but the same applies to a configuration in which the peak position P1 of the peeling pole 301 is positioned upstream of the edge 62a of the first duct wall 62 by changing the position of the edge 62a of the first duct wall 62.

Returning to FIG. 8, the configuration of Example 1 will be described. As described above, the peak position P1 of the peeling pole 301 is positioned downstream of the edge 62a of the first duct wall 62, whereas from the viewpoint of peeling property of the developer from the peeling roller 32, the peak position P1 of the peeling pole 301 is preferably set as described below. That is, it is preferable that the peak position P1 of the peeling pole 301 is positioned downstream, in the rotational direction of the peeling sleeve 35, of the peak of the peeling roller 32 in the vertical direction. Further, the peak position P1 of the peeling pole 301 is preferably positioned higher than a rotation center R of the peeling roller 32 in the vertical direction. According to this configuration, the peeling performance of the developer from the peeling roller 32 is enhanced, such that the image defects caused by the developer being co-rotated with the peeling roller 32 may be suppressed.

A relationship between the peak position P1 of the peeling pole 301 and correcting of carrier by the duct 60 according to the configurations of Example 1 of FIG. 8 and Comparative Example 1 of FIG. 9 is shown in Table 1. In Table 1, an angle of the peak position P1 is expressed by setting, among the points at which a horizontal line H (FIG. 8) that passes the rotation center R of the peeling roller 32 intersect the surface of the peeling sleeve 35, the point on the second developing roller 31 side as 0 degrees, and defining the clockwise direction of FIGS. 8 and 9, that is, the same direction as the rotational direction of the peeling sleeve 35, as positive. Further, in Table 1, in addition to Comparative Example 1 and Example 1, results having examined the collection of carrier by the duct 60 in cases where the peak position P1 is arranged at a plurality of angular positions are shown.

TABLE 1

| | PEAK POSITION P1 (°) | | | | | | |
|---|---|---|---|---|---|---|---|
| | 20 | 30 | 50 | 90 | 95 | 180 | 270 |
| COLLECTION | X | ◯ | ◯ | ⊚ | ⊚ | ⊚ | ◯ |
| OF CARRIER | | | | | | | |
| NOTE | COMPARATIVE | EDGE | | PEAK OF | EXAMPLE 1 | HEIGHT OF | LOWER THAN |
| | EXAMPLE 1 | 62a | | PEELING | | ROTATION | ROTATION |
| | | | | ROLLER 32 | | CENTER R | CENTER R |

*⊚: VERY GOOD: Carrier collection by duct 60 was sufficiently suppressed
◯: GOOD: Carrier collection by duct 60 was suppressed to a level not causing carrier clogging
X: POOR: Carrier was collected by duct 60 and carrier clogging occurred

In Table 1, “very good” indicates that collection of carrier by the duct 60 was sufficiently suppressed. “Good” indicates that collection of carrier by the duct 60 was suppressed to a level not causing clogging of carrier. “Poor” indicates that carrier was collected by the duct 60 and that clogging of carrier has occurred. Further, the case where the angle of the peak position P1 is 20° is the Comparative Example 1, and in a case where the angle is 30°, the peak position P1 is at a position facing the edge 62a. Further, in a case where the angle of the peak position P1 is 90°, the peak position P1 is at a peak of the peeling roller 32 in the vertical direction, and a case where the angle is 95° is Example 1. Further, in a case where the angle is 180°, the peak position P1 is on the opposite side from the second developing roller 31 and at a same height as the rotation center R in the vertical direction, whereas in a case where the angle is 270°, the peak position P1 is arranged lower than the rotation center R in the vertical direction. It can be recognized based on Table 1 that it is preferable to set the peak position P1 to 30° or more and 270° or less, and it is more preferable to set the peak position P1 to 90° or more and 180° or less.

Further, the position of the edge 62a of the first duct wall 62 is preferably set as follows from the viewpoint of suppressing the collection of carrier into the duct 60. That is, the edge 62a of the first duct wall 62 is preferably positioned upstream, in the rotational direction of the peeling sleeve 35, of the peak of the peeling roller 32 in the vertical direction. Further, the edge 62a of the first duct wall 62 is preferably positioned higher than the rotation center R of the peeling roller 32 in the vertical direction. According to this configuration, the collection of carrier to the duct 60 can be suppressed further.

The relationship between the position of the edge 62a of the first duct wall 62 and the collection of carrier according to the configuration of Example 1 is shown in Table 2. In Table 2, similar to the case shown in Table 1, an angle of the position of the edge 62a is expressed by setting, among the points at which a horizontal line H (FIG. 8) that passes the rotation center R of the peeling roller 32 intersect the surface of the peeling sleeve 35, the point on the second developing roller 31 side as 0 degrees, and defining the clockwise direction of FIG. 8, that is, the same direction as the rotational direction of the peeling sleeve 35, as positive. Further, in Table 2, results having examined the collection of carrier by the duct 60 in cases where the edge 62a is arranged at a plurality of angular positions are shown.

TABLE 2

| EDGE 62a POSITION OF | | | | | |
|---|---|---|---|---|---|
| FIRST DUCT WALL 62 (°) | −20 | 0 | 50 | 90 | 95 |
| COLLECTION | ◯ | ⊚ | ⊚ | ⊚ | ◯ |
| OF CARRIER | | | | | |
| NOTE | | HEIGHT OF | | PEAK OF | PEAK |
| | | ROTATION | | PEELING | POSITION |
| | | CENTER R | | ROLLER 32 | P1 |

* ⊚: VERY GOOD: Carrier collection by duct 60 was sufficiently suppressed
◯: GOOD: Carrier collection by duct 60 was suppressed to a level not causing carrier clogging

In Table 2, “very good” and “good” indicate the same states as described in Table 1. It can be recognized from Table 2 that it is preferable to set the position of the edge 62a of the first duct wall 62 to −20° or more and 95° or less, and even more preferable to set the position of the edge 62a to 0° or more and 90° or less.

In the case of Example 1, by positioning the peak position P1 of the peeling pole 301 downstream of the edge 62a of the first duct wall 62 in the rotational direction of the peeling sleeve 35, it is possible to suppress the scattered carrier from being collected into the duct 60. Further, in Example 1, the peak position P2 the feeding pole 302 is also positioned downstream of the edge 62a. Therefore, the collection of carrier by the duct 60 may be suppressed even more efficiently. As a result, the deterioration of suction ability of scattered toner by the duct 60 may be suppressed, and the scattering of toner can be suppressed for a long time.

### Example 2

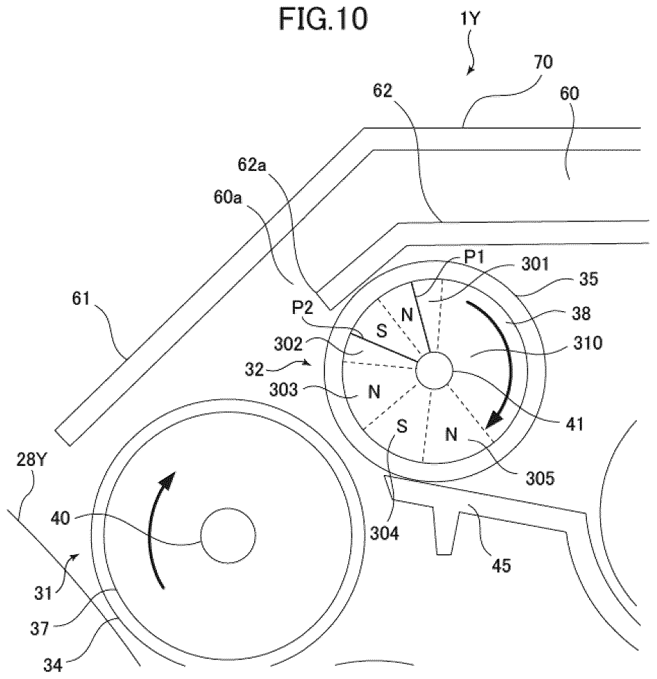

Example 2, which is one example of a configuration for suppressing scattering of carrier in the configuration of the present embodiment, will be described with reference to FIG. 10. In Example 2, the peeling magnet 38 is rotated upstream in the rotation direction from the configuration of Example 1 illustrated in FIG. 8, such that the positions of the peak position P1 of the peeling pole 301 and the peak position P2 of the feeding pole 302 are displaced with respect to Example 1. That is, in Example 2, similar to Example 1, the peak position P1 of the peeling pole 301 is positioned downstream of the edge 62a of the first duct wall 62 in the rotational direction of the peeling sleeve 35. However, in Example 2, unlike Example 1, the peak position P2 of the feeding pole 302 is positioned upstream of the edge 62a of the first duct wall 62 in the rotational direction of the peeling sleeve 35.

As according to Example 1, if the peak position P2 of the feeding pole 302 is positioned downstream of the edge 62a of the first duct wall 62 in the rotational direction of the peeling sleeve 35, the collection of carrier by the duct 60 may be suppressed further. However, as according to Example 2, if the peak position P1 of the peeling pole 301 is positioned downstream of the edge 62a of the first duct wall 62 in the rotational direction of the peeling sleeve 35, even if the peak position P2 of the feeding pole 302 is positioned upstream of the edge 62a, the collection of carrier by the duct 60 can be suppressed, though the effect thereof is lower than that of Example 1.

The relationship between the peak position P2 of the feeding pole 302 and the collection of carrier into the duct 60 according to the configuration of Example 1 of FIG. 8 and Example 2 of FIG. 10 is shown in Table 3 In Table 3, similar to the case shown in Table 1, an angle of the peak position P2 of the feeding pole 302 is expressed by setting, among the points at which a horizontal line H (FIG. 8) that passes the rotation center R of the peeling roller 32 intersect the surface of the peeling sleeve 35, the point on the second developing roller 31 side as 0 degrees, and defining the clockwise direction of FIG. 8, that is, the same direction as the rotational direction of the peeling sleeve 35, as positive. Further, in Table 3, in addition to Examples 1 and 2, a result having examined the collection of carrier into the duct 60 in a case where the peak position P2 faces the edge 62a (30°) is shown

TABLE 3

| PEAK | | | |
|---|---|---|---|
| POSITION P2 (°) | 20 | 30 | 35 |
| COLLECTION | ◯ | ⊚ | ⊚ |
| OF CARRIER | | | |
| NOTE | EXAMPLE 2 | EDGE 62a | EXAMPLE 1 |

* ⊚: VERY GOOD: Carrier collection by duct 60 was sufficiently suppressed
◯: GOOD: Carrier collection by duct 60 was suppressed to a level not causing carrier clogging

In Table 3, “very good” and “good” indicate the same states as described in Table 1. It can be recognized from Table 3 that it is preferable to set the peak position P2 of the feeding pole 302 to 20° or more, and that it is possible to sufficiently suppress the collection of carrier even if the peak position P2 faces the edge 62a. Further, it is recognized that it is more preferable to arrange the peak position P2 downstream of the edge 62a.

Such an Example 2 is effective in a case where there is a limitation in the positional relationship of the second developing roller 31, the peeling roller 32, and the first duct wall 62, and it is difficult to position the peak position P2 of the feeding pole 302 downstream of the edge 62a. Even if there is such a limitation, the collection of carrier by the duct 60 may be suppressed by positioning the peak position P1 of the peeling pole 301 downstream of the edge 62a.

### Example 3 and Example 4

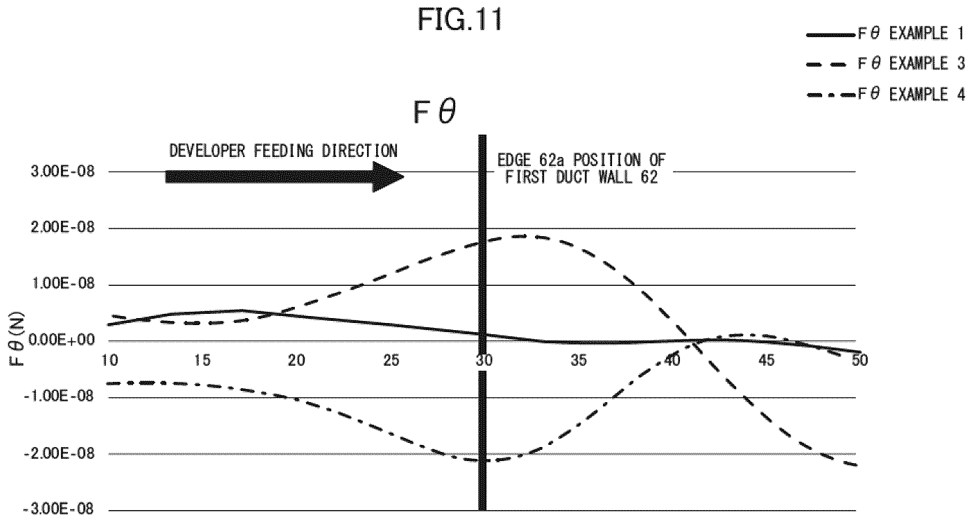

In the configuration of the present embodiment, Examples 3 and 4, which are examples of the configuration for suppressing the scattering of toner, will be described with reference to FIG. 11. In Examples 3 and 4, confirmation was performed from the viewpoint of Fθ, which is a magnetic force applied on the carrier at the position of the edge 62a of the first duct wall 62.

A magnetic flux density and a magnetic force that the peeling magnet 38 creates will be described below. In the description of the present embodiment, Br, Bθ, Fr, and Fθ are defined as follows.
Br: Magnetic flux density in a normal direction, i.e., vertical direction, with respect to an outer peripheral surface, i.e., upper surface, of the peeling sleeve 35 at a certain point
Bθ: Magnetic flux density in a tangential direction with respect to the outer peripheral surface of the peeling sleeve 35 at a certain point
Fr: Magnetic force applied in the normal direction with respect to the outer peripheral surface of the peeling sleeve 35 at a certain point, wherein an attraction direction, i.e., direction toward the peeling sleeve 35, is referred to as negative
Fθ: Magnetic force applied in the tangential direction with respect to the outer peripheral surface of the peeling sleeve 35 at a certain point, wherein the rotational direction of the peeling sleeve 35 is referred to as positive

Unless denoted otherwise, Br, Bθ, Fr, and Fθ refer to the magnetic flux density or the magnetic force at a certain point on the peeling sleeve 35.

### Method for Measuring Magnetic Force or Magnetic Flux Density

Next, a method for measuring a magnetic force according to the present embodiment will be described. The magnetic force according to the present embodiment can be calculated by a calculation method described below. The magnetic force acting on the carrier can be obtained by the following Expression (1). In the Expression, μ₀ represents the magnetic permeability of vacuum, u represents the magnetic permeability of the carrier, b represents the radius of the carrier, and B represents the magnetic flux density.

$$Expression ( 1 )$$

$$\vec{F} = \frac{μ - {μ}_{0}}{{μ}_{0} ( μ + 2 {μ}_{0} )} 2 π {b}^{3} ∇ {B}^{2} \qquad ( 1 )$$

$$Therefore ,$$

$$Expression ( 2 )$$

$$\begin{matrix}\vec{F} ∝ ∇ {B}^{2} \\ = \frac{\partial }{\partial r} ( {Br}^{2} + B {θ}^{2} ) \vec{{e}_{r}} + \frac{l}{r} \frac{\partial }{\partial θ ( {B}_{r}^{2} + {B}_{θ}^{2} )} {\vec{e}}_{0} \\ ∴ \vec{F} ∝ {\underbrace{( {B}_{r} \frac{\partial {B}_{r}}{\partial r} + {B}_{θ} \frac{\partial {B}_{0}}{\partial r} ) {\vec{e}}_{r}}}_{Fr} + {\underbrace{\frac{l}{r} ( {B}_{r} \frac{\partial {B}_{r}}{\partial θ} + {B}_{θ} \frac{\partial {B}_{θ}}{\partial θ} ) {\vec{e}}_{θ}}}_{F θ}\end{matrix} \qquad ( 2 )$$

Based on Expression (2), Fr and Fθ can be calculated by acquiring Br and Bθ. The magnetic flux density Br was measured using a magnetic field measuring instrument “MS-9902” (Product Name) manufactured by F. W. BELL as the measuring instrument and setting the distance between a probe, which is a member of the measuring instrument, and the upper surface of the developing sleeve to approximately 100 μm.

Further, Bθ may be obtained by the following method. A vector potential A_{z} (R, θ) at a measurement position of the magnetic flux density Br can be obtained using the measured magnetic flux density Br by the following expression.

$$Expression ( 3 )$$

$${A}_{z} ( R , θ ) = {{\int }^{0}}_{0} RBrd θ \qquad ( 3 )$$

A_{z} (r,θ) is obtained by setting the boundary condition to A_{z} (R, θ) and solving the following expression,

$${∇}^{2} {A}_{z} ( R , θ ) = 0$$

Then, Br and Bθ are obtained by the following expressions.

$$Expression ( 4 )$$

$${B}_{r} = \frac{I}{r} \frac{\partial {A}_{z} ( r , θ )}{\partial θ} \qquad ( 4 )$$

$$Expression ( 5 )$$

$${B}_{θ} = - \frac{\partial {A}_{z} ( r , θ )}{\partial r} \qquad ( 5 )$$

Fr and Fθ may be obtained by applying Br and Bθ measured and computed as described above to Expression (1). Further, based on the above Expression, the Fr distribution that is required according to the present embodiment may be obtained.

In Example 3, when setting the magnetic force applied on the peeling sleeve 35 in the tangential direction is set to Fθ, the force of Fθ applied in the same direction as the rotational direction of the peeling sleeve 35 as positive, and the force of Fθ applied in the opposite direction as the rotational direction of the peeling sleeve 35 as negative, the Fθ on the peeling sleeve 35 corresponding to the edge 62a of the first duct wall 62 is set to +1.5×10⁻⁸ N. Meanwhile, in Example 4, the Fθ on the peeling sleeve 35 corresponding to the edge 62a of the first duct wall 62 is set to −1.5×10⁻⁸ N. FIG. 11 illustrates a graph of the distribution of Fθ in the vicinity of the position of the edge 62a of the first duct wall 62 according to Examples 1, 3, and 4.

In Example 1, the Fθ on the peeling sleeve 35 corresponding to the position of the edge 62a is approximately 0, and extremely small. In Example 3, a peeling magnet 38 was used in which the Fθ on the peeling sleeve 35 corresponding to the position of the edge 62a is greater than that of Example 1. In Example 4, a peeling magnet 38 was used in which the Fe on the peeling sleeve 35 corresponding to the position of the edge 62a is smaller than that of Example 1. The collection of carrier into the duct 60 was confirmed for each of the Examples.

In Example 3, the Fe on the peeling sleeve 35 corresponding to the position of the edge 62a is set large, such that the speed in which the developer moves on the peeling sleeve 35 corresponding to the position of the edge 62a becomes faster than the rotating speed of the peeling roller 32. Therefore, the centrifugal force acting on the carrier is large, and the carrier is easily released from the peeling roller 32. Therefore, compared to Example 1, the carrier is easily collected into the duct 60.

Meanwhile, in Example 4, the Fθ on the peeling sleeve 35 corresponding to the position of the edge 62a is set small, such that the speed in which the developer moves on the peeling sleeve 35 corresponding to the position of the edge 62a becomes slower than the rotating speed of the peeling roller 32. Therefore, the centrifugal force acting on the carrier is small, and the carrier is not easily released from the peeling roller 32. However, the moving speed of the developer is slow, such that the height of the developer on the peeling roller 32 tends to become high. Therefore, in Example 4, the height of the developer on the peeling roller 32 exceeded the closest distance A between the peeling roller 32 and the first duct wall 62. Therefore, the developer was retained at the position of the closest distance A between the peeling roller 32 and the first duct wall 62, and the developer could not be conveyed appropriately by the peeling roller 32, such that reverse flow of the developer occurred. By having the developer return toward the opposing portion 74, co-rotation of the developer on the second developing roller 31 occurred, and image defects tended to occur.

As described above, the configuration of Example 1 enabled to suppress the occurrence of retention of the developer at the closest distance A position, and to suppress the collection of the carrier to the duct 60 the most.

The relationship between the Fθ on the peeling sleeve 35 corresponding to the position of the edge 62a and the retention of developer and collection of carrier by the duct 60 corresponding to the configurations of Examples 1, 3, and 4 is illustrated in Table 4. In Table 4, in addition to Examples 1, 3, and 4, cases where Fθ is −1.0×10⁻⁸ N (−1.0E-08) and where Fθ is +1.0×10⁻⁸ N (1.0E-08) are shown. The Fθ of Example 1 is +0.9×10⁻⁹ N (0.9E-09), the Fθ of Example 3 is +1.5×10⁻⁸ N (1.5E-08), and the Fθ of Example 4 is −1.5×10⁻⁸ N (−1.5E-08).

TABLE 4

| Fθ (N) | −1.5E−08 | −1.0E−08 | 0.9E−09 | 1.0E−08 | 1.5E−08 |
|---|---|---|---|---|---|
| COLLECTION | ⊚ | ⊚ | ⊚ | ⊚ | ◯ |
| OF CARRIER | | | | | |
| RETENTION OF | ◯ | ⊚ | ⊚ | ⊚ | ⊚ |
| DEVELOPER | | | | | |
| NOTE | EXAMPLE 4 | | EXAMPLE 1 | | EXAMPLE 3 |

*COLLECTION OF CARRIER
⊚: VERY GOOD: Carrier collection by duct 60 was sufficiently suppressed
◯: GOOD: Carrier collection by duct 60 was suppressed to a level not causing carrier clogging
*RETENTION OF DEVELOPER
⊚: VERY GOOD: No retention of developer occurred at position of closest distance A
◯: GOOD: Some retention of developer occurred at position of closest distance A, but image defect that occurred along therewith was within permissible range

In Table 4, “very good” and “good” in the “collection of carrier” column indicates the same states as described in Table 1. Further, “very good” in the “retention of developer” column indicates that no retention of developer occurred at the position of the closest distance A. “Good” refers to a state where some retention of developer occurred at the position of the closest distance A, but the image defect that occurred along therewith was within a permissible range.

Based on Table 4, it was recognized that from the viewpoint of suppressing retention of developer at the position of the closest distance A, it is preferable to set the Fθ on the peeling sleeve 35 corresponding to the position of the edge 62a of the first duct wall to +1.5×10⁻⁸ N or less. Further, from the viewpoint of suppressing the collection of carrier by the duct 60, it is preferable to set the Fθ on the peeling sleeve 35 corresponding to the edge 62a of the first duct wall to −1.5×10⁻⁸ N or more. Further, from the viewpoint of both the suppression of retention of developer and the suppression of collection of carrier by the duct 60, it is preferable to set the Fθ on the peeling sleeve 35 corresponding to the edge 62a of the first duct wall to −1.0×10⁻⁸ N or more and +1.0×10⁻⁸ N or less.

In Example 3, the Fθ on the peeling sleeve 35 corresponding to the position of the edge 62a is set greater than Example 1, such that the retention of developer at the position of the closest distance A may be suppressed compared to Example 1. However, Example 1 enables to suppress the retention of developer and the collection of carrier by the duct 60 compared to Example 3. In Example 4, the Fθ on the peeling sleeve 35 corresponding to the position of the edge 62a is set smaller than that of Example 1, such that the carrier is not easily scattered, and the retention of developer and collection of carrier by the duct 60 may be suppressed similarly as Example 1 or may be suppressed even more than Example 1. However, Example 1 enables to suppress the retention of developer at the position of the closest distance A compared to Example 4. Therefore, from the viewpoint of both the suppression of retention of developer and the suppression of collection of carrier by the duct 60, Example 1 is most preferable.

### Example 5

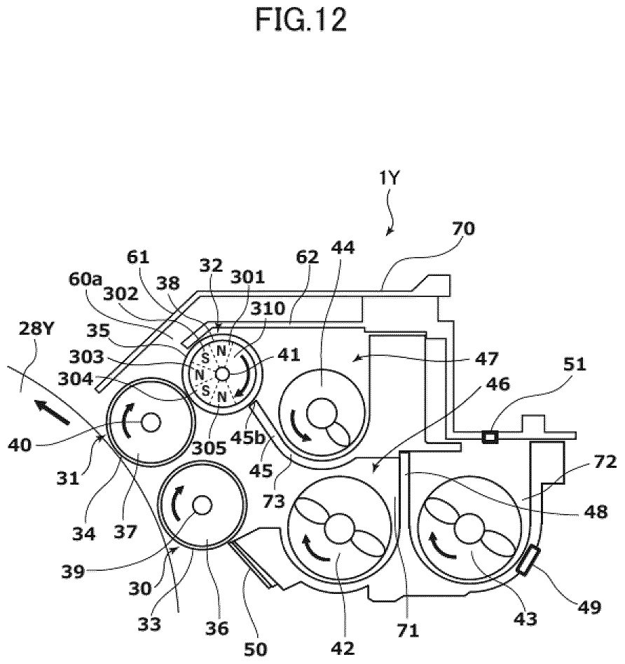

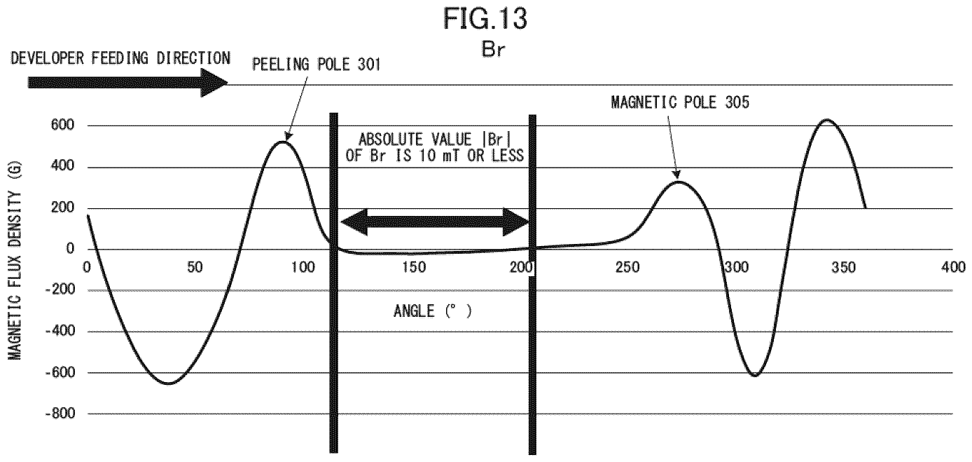

In the configuration of the present embodiment, Example 5, which is an example of the configuration for suppressing the scattering of carrier, will be described with reference to FIGS. 12 and 13. In Example 5, the position of the guide member 45 guiding the developer to the developer collecting screw 44 was changed with respect to the configuration of Example 1. That is, in Example 5, in a state where the normal component of magnetic flux density on the peeling sleeve 35 is referred to as Br, as illustrated in FIG. 12, an edge 45b of the guide member 45 on the peeling roller 32 side faces a region where the absolute value of Br is 10 mT or less, preferably 5 mT or less. The configuration of the peeling magnet 38 within the peeling roller 32 is the same as that of Example 1.

As illustrated in FIG. 12, the edge 45b of the guide member 45 is arranged in proximity to a position facing the low magnetic force portion 310 of the peeling magnet 38. Since the low magnetic force portion 310 is a region in which the developer is peeled off from the peeling sleeve 35, by arranging the edge 45b of the guide member 45 at a position facing the low magnetic force portion 310 as according to Example 4, the peeling property of the developer from the peeling roller 32 may be improved and the conveyance performance of the developer to the developer collecting screw 44 may be improved compared to the configuration of Example 1. As a result, the co-rotation of the developer on the peeling roller 32 may be suppressed, and the image quality of the output image can be improved.

FIG. 13 is a graph illustrating the distribution of Br at the positions of the respective magnetic poles of the magnetic field generated by the peeling magnet 38 inside the peeling roller 32. By disposing the edge 45b of the guide member 45 in a region where the absolute value |Br| of Br is 10 mT or less, the peeling performance of the developer from the peeling roller 32 can be enhanced.

The relationship between the position of the edge 45b of the guide member 45 and peelability of the developer from the peeling roller 32 according to the configurations of Examples 1 and 5 is shown in Table 5. In Table 5, similar to the case shown in Table 1, an angle of the position of the edge 45b of the guide member 45 is expressed by setting, among the points at which the horizontal line H (FIG. 8) that passes the rotation center R of the peeling roller 32 intersect the surface of the peeling sleeve 35, the point on the second developing roller 31 side as 0 degrees, and defining the clockwise direction of FIG. 8, that is, the same direction as the rotational direction of the peeling sleeve 35, as positive. Further, in Table 5, in addition to Examples 1 and 5, the results having examined the peelability of developer from the peeling roller 32 in a case where the position of the edge 45b of the guide member 45 is set to positions other than those of Examples 1 and 5 are shown.

TABLE 5

| EDGE 45b POSITION OF | | | | | |
|---|---|---|---|---|---|
| GUIDE MEMBER 45 (°) | 100 | 110 | 190 | 200 | 280 |
| PEELABILITY | Δ | ⊚ | ⊚ | ⊚ | ◯ |
| NOTE | | | EXAMPLE 5 | | EXAMPLE 1 |

*⊚: VERY GOOD: Peelability of developer from peeling roller 32 was satisfactory
◯: GOOD: Peelability of developer from peeling roller 32 was somewhat deteriorated but within a level not influencing output image
Δ: AVERAGE: Peelability of developer from peeling roller 32 was deteriorated and output image was somewhat influenced

In Table 5, “very good” indicates that the peelability of developer from the peeling roller 32 was satisfactory. “Good” indicates that the peelability of developer from the peeling roller 32 was somewhat deteriorated but within a level not influencing the output image. “Average” indicates that the peelability of developer from the peeling roller 32 was deteriorated and the output image was somewhat influenced.

It was recognized based on Table 5 that it is preferable to set the position of the edge 45b of the guide member 45 to 110° or more and 280° or less. Further, it was recognized that it is more preferable to set the position of the edge 45b of the guide member 45 within the range of 110° or more and 200° or less.

In Example 5, sine the edge 45b of the guide member 45 on the peeling roller side faces the region in which the absolute value of Br is 10 mT or less, compared to the configuration of Example 1, the peelability of the developer from the peeling roller 32 may be improved. As a result, the co-rotation of developer on the peeling roller 32 is suppressed, and the image quality of the output image can be improved.

### Experiment

The following experiment was performed to confirm the effects of the respective configurations of Examples 1 to 5, Comparative Example 1 (FIG. 9), and the conventional example (FIG. 7). The developing apparatuses of the respective configurations were attached to the image forming apparatus illustrated in FIG. 1, and image formation was performed to 5000 sheets. In the respective configurations, the scattering of toner within the developing apparatus, the collection of carrier into the duct 60, the retention of developer at the position of the closest distance A, and the peelability of developer from the peeling roller 32 were confirmed and evaluated. As for the conventional example, the duct 60 is not provided, such that items other than scattering of toner were not evaluated. As for Comparative Example 1, the peak position P1 of the peeling pole 301 is disposed upstream of the edge 62a of the first duct wall 62 in the rotational direction of the peeling sleeve 35, such that the retention of developer was not evaluated. The results of the experiment are shown in Table 6.

TABLE 6

| | | COLLECTION | RETENTION | PEELABILITY |
|---|---|---|---|---|
| | TONER | OF CARRIER | OF | OF |
| | SCATTERING | INTO DUCT | DEVELOPER | DEVELOPER |
| CONVENTIONAL | X | — | — | — |
| EXAMPLE | | | | |
| COMPARATIVE | ◯ | X | — | X |
| EXAMPLE 1 | | | | |
| EXAMPLE 1 | ◯ | ⊚ | ⊚ | ◯ |
| EXAMPLE 2 | ◯ | ◯ | ⊚ | ◯ |
| EXAMPLE 3 | ◯ | ◯ | ⊚ | ◯ |
| EXAMPLE 4 | ◯ | ⊚ | ◯ | ◯ |
| EXAMPLE 5 | ◯ | ⊚ | ⊚ | ⊚ |

*TONER SCATTERING
◯: GOOD: Toner scattering in developing apparatus was sufficiently suppressed
X: POOR: Toner scattering has occurred in developing apparatus
*Collection of carrier into duct
⊚: VERY GOOD: Carrier collection by duct 60 was sufficiently suppressed
◯: GOOD: Carrier collection by duct 60 was suppressed to a level not causing carrier clogging
X: POOR: Carrier was collected by duct 60 and carrier clogging occurred
*Retention of developer
⊚: VERY GOOD: No retention of developer occurred at position of closest distance A
◯: GOOD: Some retention of developer occurred at position of closest distance A, but image defect that occurred along therewith was within permissible range
*Peelability of developer
⊚: VERY GOOD: Peelability of developer from peeling roller 32 was satisfactory
◯: GOOD: Peelability of developer from peeling roller 32 was somewhat deteriorated but within a level not influencing output image
Δ: AVERAGE: Peelability of developer from peeling roller 32 was deteriorated and output image was somewhat influenced

In Table 6, “good” in “toner scattering” indicates that the toner scattering in the developing apparatus was sufficiently suppressed. “Poor” indicates that toner scattering has occurred in the developing apparatus. Further, “very good”, “good”, and “poor” in the “collection of carrier into duct” column indicate the same states as described in Table 1. “Very good” and “good” in the “retention of developer” column indicate the same states as described in Table 4. “Very good” and “good” in the “peelability of developer” column indicate the same states as described in Table 5. “Poor” in the “peelability of developer” indicates that the peelability of the developer from the peeling roller 32 is deteriorated and the output image has been influenced.

As can be seen from Table 6, the Comparative Example 1 and Examples 1 to 5, other than the conventional example, include the duct 60, such the toner scattering within the developing apparatus was sufficiently suppressed. Further, according to Comparative Example 1, the peak position P1 of the peeling pole 301 was disposed upstream of the edge 62a of the first duct wall 62 in the rotational direction of the peeling sleeve 35, such that compared to Examples 1 to 5, the evaluation regarding collection of carrier into duct and peelability of developer were not good. As for the collection of carrier into duct, among Examples 1 to 5, the evaluations of Examples 1, 4, and 5 were high. As for the retention of developer, among Examples 1 to 5, the evaluations of Examples other than Example 4 were high. Even further, as for the peelability of developer, Examples 1 to 4 were okay, but the evaluation of Example 5 was high.

### Other Embodiments

The respective embodiments were described based on a developing apparatus including two developing rollers, but the present disclosure is also applicable to a configuration having only one developing roller. That is, the present disclosure is applicable to a configuration in which there is one developing roller for developing the electrostatic latent image on an image developing member, such as a photosensitive drum, and in which a peeling roller for peeling the developer from the developing roller is provided.

The present invention is not limited to the configuration of each embodiment described above. For example, the image forming apparatus 100 is not limited to the MFP, and may be a copier, a printer, or a facsimile machine. Further, the configurations of the developer supplying screw 42, the developer stirring screw 43, and the developer collecting screw 44 are not particularly limited as long as the developer can be fed, and for example, a spiral blade or a paddle blade can be applied.

According to the present disclosure, collection of carrier by the duct may be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-184367, filed Oct. 18, 2024 which is hereby incorporated by reference herein in its entirety.

What is claimed is:

1. A developing apparatus comprising:
a developing container including a first chamber configured to contain a developer including a toner and a carrier, and a second chamber partitioned from the first chamber by a partition wall;
a first rotatable developing member to which the developer is supplied, the first rotatable developing member being configured to carry and feed the developer to a developing position where an electrostatic latent image formed on an image bearing member is developed;
a first magnet provided non-rotatably and stationarily inside the first rotatable developing member, the first magnet having a first magnetic pole provided to face the image bearing member at the developing position, a second magnetic pole provided downstream of the first magnetic pole in a rotational direction of the first rotatable developing member, and a third magnetic pole provided downstream of the second magnetic pole and adjacent to the second magnetic pole, with respect to the rotational direction of the first rotatable developing member, and having a same magnetic polarity as that of the second magnetic pole;
a second rotatable developing member disposed to face the first rotatable developing member and configured to receive the developer delivered from the first rotatable developing member by a magnetic field generated by the first magnet, the second rotatable developing member being configured to carry and feed the developer after developing the electrostatic latent image in the second chamber to collect the developer in the second chamber;
a second magnet provided non-rotatably and stationarily inside the second rotatable developing member, the second magnet having a fourth magnetic pole having a different magnetic polarity from that of the second magnetic pole, a fifth magnetic pole provided downstream of the fourth magnetic pole with respect to a rotational direction of the second rotatable developing member, a sixth magnetic pole provided downstream of the fifth magnetic pole and adjacent to the fifth magnetic pole, with respect to the rotational direction of the second rotatable developing member, and having a different magnetic polarity from that of the fifth magnetic pole, and a seventh magnetic pole provided downstream of the sixth magnetic pole and adjacent to the sixth magnetic pole, with respect to the rotational direction of the second rotatable developing member, and having a same magnetic polarity as that of the sixth magnetic pole, wherein the developer after developing the electrostatic latent image is delivered from the first rotatable developing member to the second rotatable developing member by a magnetic field generated between the second magnetic pole and the fourth magnetic pole; and
a duct including
a suction port that is an inlet through which the developer scattered in the developing container is sucked, the suction port being disposed downstream, in the rotational direction of the second rotatable developing member, of a position at which the first rotatable developing member and the second rotatable developing member face each other,
a first duct wall configured to extend downstream, in the rotational direction of the second rotatable developing member, of the suction port, the first duct wall disposed to face a part of the second rotatable developing member with a gap therebetween, and
a second duct wall disposed to face the first duct wall and configured to form a space between the second duct wall and the first duct wall through which the developer sucked from the suction port flows, the second duct wall being positioned on an outer side than the first duct wall with respect to a rotation center of the second rotatable developing member in a direction from the rotation center of the second rotatable developing member toward a position on an outer peripheral surface of the second rotatable developing member where an absolute value of a normal component of a magnetic flux density of the sixth magnetic pole becomes maximum,
wherein the rotational direction of the second rotatable developing member is opposite from the rotational direction of the first rotatable developing member at the position at which the first rotatable developing member and the second rotatable developing member face each other, and
wherein the position on the outer peripheral surface of the second rotatable developing member where the absolute value of the normal component of the magnetic flux density of the sixth magnetic pole becomes maximum is positioned downstream of an edge of the first duct wall on the suction port side with respect to the rotational direction of the second rotatable developing member.

2. The developing apparatus according to claim 1,
wherein the position on the outer peripheral surface of the second rotatable developing member where an absolute value of a normal component of a magnetic flux density of the fifth magnetic pole becomes maximum is positioned downstream of the edge of the first duct wall on the suction port side with respect to the rotational direction of the second rotatable developing member.

3. The developing apparatus according to claim 1,
wherein, in a state where a magnetic force applied to the outer peripheral surface of the second rotatable developing member in a normal direction is referred to as Fθ, a sign of the Fθ when a direction of the Fθ is a same direction as the rotational direction of the second rotatable developing member is positive, and the sign of the Fθ when the direction of the Fθ is an opposite direction from the rotational direction of the second rotatable developing member is negative,
the Fθ at a position on the outer peripheral surface of the second rotatable developing member corresponding to the edge of the first duct wall on the suction port side is +1.5×10⁻⁸ N or less.

4. The developing apparatus according to claim 3,
wherein the Fθ at a position on the outer peripheral surface of the second rotatable developing member corresponding to the edge of the first duct wall on the suction port side is +1.0×10⁻⁸ N or less.

5. The developing apparatus according to claim 1,
wherein, in a state where a magnetic force applied to the outer peripheral surface of the second rotatable developing member in a normal direction is referred to as Fθ, a sign of the Fe when a direction of the Fθ is a same direction as the rotational direction of the second rotatable developing member is positive, and the sign of the Fθ when the direction of the Fθ is an opposite direction from the rotational direction of the second rotatable developing member is negative,
the Fθ at a position on the outer peripheral surface of the second rotatable developing member corresponding to the edge of the first duct wall on the suction port side is −1.5×10⁻⁸ N or more.

6. The developing apparatus according to claim 5,
wherein the Fθ at a position on the outer peripheral surface of the second rotatable developing member corresponding to the edge of the first duct wall on the suction port side is −1.0×10⁻⁸ N or more.

7. The developing apparatus according to claim 1, further comprising:
a guide portion disposed to face the second rotatable developing member and configured to guide the developer peeled off from the second rotatable developing member to the second chamber,
wherein an edge of the guide portion on the second rotatable developing member side is configured to face a region on the outer peripheral surface of the second rotatable developing member where an absolute value of a normal component of a magnetic flux density is 10 mT or less with respect to the outer peripheral surface of the second rotatable developing member.

8. The developing apparatus according to claim 1,
wherein the edge of the first duct wall on the suction port side is positioned upstream, in the rotational direction of the second rotatable developing member, of a peak of the second rotatable developing member in a vertical direction.

9. The developing apparatus according to claim 8,
wherein the edge of the first duct wall on the suction port side is positioned higher than the rotation center of the second rotatable developing member in the vertical direction.

10. The developing apparatus according to claim 1,
wherein a position on the outer peripheral surface of the second rotatable developing member where the absolute value of the normal component of the magnetic flux density of the sixth magnetic pole becomes maximum is positioned downstream, in the rotational direction of the second rotatable developing member, of a peak of the second rotatable developing member in a vertical direction.

11. The developing apparatus according to claim 10,
wherein the position on the outer peripheral surface of the second rotatable developing member where the absolute value of the normal component of the magnetic flux density of the sixth magnetic pole becomes maximum on the outer peripheral surface of the second rotatable developing member is positioned higher than the rotation center of the second rotatable developing member in the vertical direction.

12. The developing apparatus according to claim 1,
wherein the second duct wall is configured to extend further toward the first rotatable developing member than the edge of the first duct wall on the suction port side.

13. The developing apparatus according to claim 1, further comprising:
a conveyance portion disposed in the second chamber and configured to convey the developer within the second chamber; and
a communication portion configured to allow the developer to communicate from the second chamber to the first chamber.

14. The developing apparatus according to claim 1, further comprising:
a third chamber configured to be partitioned from the first chamber by another partition wall that differs from the partition wall;
a first conveyance portion disposed in the first chamber and configured to convey the developer in the first chamber;
a second conveyance portion disposed in the second chamber and configured to convey the developer in the second chamber;
a third conveyance portion disposed in the third chamber and configured to convey the developer in the third chamber;
a first communication portion configured to allow the developer to communicate from the third chamber to the first chamber;
a second communication portion configured to allow the developer to communicate from the first chamber to the third chamber; and
a third communication portion configured to allow the developer to communicate from the second chamber to the first chamber.

15. The developing apparatus according to claim 1, further comprising:
a third rotatable developing member disposed to face the first rotatable developing member and configured to receive the developer contained in the first chamber, the third rotatable developing member being configured to carry and feed the developer to develop the electrostatic latent image; and
a third magnet provided non-rotatably and stationarily inside the third rotatable developing member,
wherein the rotational direction of the first rotatable developing member is opposite from a rotational direction of the third rotatable developing member at a position at which the first rotatable developing member and the third rotatable developing member face each other, and
wherein the first rotatable developing member is configured to receive the developer delivered from the third rotatable developing member by a magnetic field generated by the third magnet.
